(19) United States
(12) Patent Application Publication
(10) Pub. No.: US 2014/0316796 A1
(43) Pub. Date: Oct. 23, 2014

(54) SYSTEMS, METHODS, AND COMPUTER-READABLE MEDIA FOR LIMITED DISTRIBUTION OF SPECIALTY DRUG USING A COMPUTER HUB OPERATING AT A SINGLE ACCESS POINT

(71) Applicant: Jazz Pharmaceuticals, Palo Alto, CA (US)

(72) Inventor: Russell COX, Alamo, CA (US)

(21) Appl. No.: 14/256,860

(22) Filed: Apr. 18, 2014

Related U.S. Application Data
(60) Provisional application No. 61/814,172, filed on Apr. 19, 2013.
(60) Provisional application No. 61/973,043, filed on Mar. 31, 2014.

(51) Int. Cl. G06F 19/00

(52) U.S. Cl. CPC G06F 19/3456; G06F 19/322; G06F 19/328
USPC 705/2

(57) ABSTRACT

Embodiments of the present invention provides systems, methods, and computer-readable media for distributing a specialty drug, such as an omega conopeptide, using a computer hub that facilitates reimbursement assistance, higher expertise in handling, better care of the product, and reduced patient cost. For example, responsive to a prescription, if the patient is currently enrolled in a commercial insurance plan, a patient out-of-pocket requirement can be compared to a capped payment amount. If the patient out-of-pocket requirement exceeds the capped payment amount, a total invoice amount of the specialty drug can be divided by a total invoice amount of the prescription to obtain a percentage of the total invoice attributable to the specialty drug, that percentage multiplied by the patient out-of-pocket requirement to obtain an initial patient obligation for only the specialty drug, and the initial patient obligation for only the specialty drug reduced to the capped payment amount.

### CROSS-REFERENCE TO RELATED APPLICATIONS

This application claims priority to and the benefit of the following applications, the entire contents of each of which (including any and all figures) are incorporated by reference herein:

U.S. Provisional Patent Application No. 61/814,172, entitled “Hub for Limited Distribution of Specialty Drug” and filed on Apr. 19, 2013; and

U.S. Provisional Patent Application No. 61/973,043, entitled “Hub for Limited Distribution of Specialty Drug” and filed on Mar. 31, 2014.

### FIELD

This application relates to systems, methods, and computer-readable media for distribution of a specialty drug, such as an omega conopeptide.

### BACKGROUND

Omega conopeptides are a class of specialty drug that has been provided for analgesia alone and in combination with other analgesics. This administration can be by an implantable pump.

Ziconotide (commercially available under the trade name PRIALT® from Jazz Pharmaceuticals, Inc., Dublin, Ireland) is a 25 amino acid peptide that is delivered intrathecally (IT) for treatment of severe chronic pain. Being a peptide, there are very specific handling requirements that must be in place to ensure viability of the pharmaceutical product. In one embodiment, ziconotide is refrigerated throughout its handling, shipping and storage and it is not frozen. In another embodiment, ziconotide should remain between pH 4.0-5.0. In further embodiments, each vial is intended for single use. In a still further embodiment, the 25 mcg/ml formulation of ziconotide may lose stability when diluted. The 100 mcg/ml formulation of ziconotide can be diluted, as additives (methionine) have been included to improve stability. Combination or admixture of ziconotide with other intrathecal agents, such as opioids, also can reduce stability of the ziconotide. For further information about administering ziconotide in combination with analgesics, see U.S. Pat. No. 8,653,033 to Ellis et al., the entire contents of which are incorporated by reference herein. Ziconotide should be protected from light. Ziconotide is a complex product, where proper handling is essential to ensuring viability of the product. Accordingly, what is needed are systems, methods, and computer-readable media for distributing specialty drugs like ziconotide and pharmacy services so as to improve product-specific knowledge and consistency in product handling and reduce computer resources.

### SUMMARY

One embodiment of the present invention provides systems, methods, and computer-readable media for limited distribution of a specialty drug using a computerized centralized distribution model (or “hub”) operating at a single access point. Utilizers, such as providers and patients, of specialty drugs, such as drugs like analgesics, for example omega conopeptides and/or ziconotide, can benefit from distribution from such a computer hub. The hub can facilitate ordering, reimbursement assistance, financial assistance research, regulations to improve handling of the drug, such as ziconotide, education on drug use and stability, and can improve the efficiency of processing and transmitting information among the hub, the pharmacy, and the physician, e.g., by reducing the computer resources, such as bandwidth, needed to transmit information from the hub to the pharmacy or physician, and also can reduce administrative burden. Another aspect of the hub is to limit distribution and pharmacy services of the specialty drug, e.g., ziconotide, to a small number of pharmacies, such as one pharmacy, or two pharmacies, to improve product-specific knowledge and consistency in product handling, e.g., specialized handling procedures. Additionally, limiting the pharmacies that can compound the drug helps ensure that ziconotide remains stable/viable because such pharmacies can be specifically educated in specialized prescription filling procedures for the specialty drug. For example, providing educational materials and training for product stability prior to administration, as well as admixing in office/site of administration. This process promotes high-quality services and expertise in high-risk compounding. Other advantages of the hub and its process for operation include just in time delivery of the product and handling protocols so that the specialty drug, e.g., ziconotide, remains refrigerated throughout shipping and storage and is not frozen. The above handling procedures enhance consistency and thereby improve patient safety. Additionally, certain embodiments of the present hub may provide patient-level ordering and distribution, meaning that one prescription may be prepared per patient so as to enhance safety, rather than preparing “batches” or “lots” of drug.

Limiting distribution and pharmacy services of a specialty drug, such as ziconotide, to a small number of pharmacies, such as 1-2 pharmacies, may centralize data collection and facilitate the capture and analysis of trends in handling, ordering and reimbursement for the specialty drug. In response to negative trends that are observed, processes and improvements can be put in place to improve product handling, product education and increase patient access to the specialty drug, e.g., ziconotide.

Limiting distribution and pharmacy services of a specialty drug, such as ziconotide, to a small number of pharmacies, such as 1-2 pharmacies, enhances education on the stability and handling of the specialty drug, product warnings, and, as appropriate, pump compatibility as well as methods of using the drug, e.g., ziconotide, in various available intrathecal pumps. The limited distribution network can provide education to physicians and healthcare professionals on patient-specific information regarding their prescription of the specialty drug, e.g., ziconotide, including but not limited to estimated stability of the drug in the particular prescription prescribed for each patient and recommended refill timing based on this prescription-specific product stability. Assigned service agents for each account (physician's office) results in relationships that aid in the education of physicians and healthcare professionals regarding use and handling of the specialty drug, e.g., ziconotide, and its preparations.

Limiting distribution and pharmacy services of a specialty drug, e.g., ziconotide, to a small number of pharmacies, such as 1, 2, or 3 pharmacies allows improved reimbursement services, benefit investigation, and knowledge of patient-specific reimbursement coverage and required payment options in advance of filling prescriptions for the drug, e.g., ziconotide, improved access to patient assistance for reducing patient out-of-pocket costs for the drug, e.g., ziconotide, simplified ordering, and streamlined billing and shipping. This information should help increase physician's confidence in obtaining reimbursement, and reduce the physician's concern for the patient's financial burden. Thus physicians can choose the drug for administration, e.g., via an intrathecal pump, based upon clinical factors rather than reimbursement issues. Additionally, the provider may select among different billing methods, such as Direct Bill or buy and bill, such as described in greater detail below.

Under one aspect of the present invention, a method is provided for distributing a specialty drug with increased safety and reduced patient cost. The specialty drug may require specialized handling procedures and specialized prescription filling procedures. The method may include, by a computer hub operating at a single access point, enrolling a plurality of physicians and permitting the enrolled physicians to administer the specialty drug, to the exclusion of any other physicians. Using the specialized handling procedures, the specialty drug may be distributed from the single access point to a pharmacy specifically educated in the specialized handling procedures and the specialized prescription filling procedures, for delivery from the pharmacy exclusively to enrolled physicians responsive to prescriptions by those enrolled physicians for corresponding patients. Each prescription is for at least the specialty drug. Any pharmacies that are not specifically educated in the specialized handling procedures and the specialized prescription filling procedures can be excluded from the distribution. At the single access point, for each prescription, responsive to that prescription, it may be determined whether the patient is currently enrolled in a commercial insurance plan. Based upon the patient currently being enrolled in a commercial insurance plan, a patient out-of-pocket requirement of the commercial insurance plan may be determined and compared to a capped payment amount. Based upon the patient out-of-pocket requirement exceeding the capped payment amount, a total invoice amount of the specialty drug divided by a total invoice amount of the prescription may be calculated to obtain a percentage of the total invoice attributable to the specialty drug. This percentage then may be multiplied by the patient out-of-pocket requirement to obtain an initial patient obligation for only the specialty drug. The initial patient obligation for only the specialty drug may be reduced to the capped payment amount.

In some embodiments, the pharmacy receives the prescription for at least the specialty drug from one of the enrolled physicians; fills the prescription of the specialty drug using the specialized prescription filling procedures; and delivers the filled prescription exclusively to the one of the enrolled physicians using the specialized handling procedures. In some embodiments, the one of the enrolled physicians intrathecally administers to the patient a therapeutically effective dose of the delivered, filled prescription.

In some embodiments, the specialized handling procedures include just in time delivery of the specialty drug and refrigerating the specialty drug so that the drug remains refrigerated throughout distribution and is not frozen.

In some embodiments, the specialized prescription filling procedures include preparing the prescription of the specialty drug exclusively for the patient, rather than as a portion of a batch that is prepared for multiple patients and divided.

In some embodiments, the specialized prescription filling procedures include admixing the specialty drug by the pharmacy with another drug.

In some embodiments, the pharmacy provides information about specialized administration procedures to the physician. This information can include instructions for admixing the specialty drug by the physician with another drug.

In some embodiments, the pharmacy provides information about specialized administration procedures to the physician. This information can include instructions for intrathecally administering the specialty drug via a bolus injection, an intermittent pulse, or a continuous infusion.

In some embodiments, the pharmacy provides information about specialized administration procedures to the physician. This information can include one or more of estimated intrathecal pump refill timing, intrathecal pump marketplace warnings, intrathecal pump compatibility, and methods of using the specialty drug in different intrathecal pumps.

In some embodiments, the specialty drug includes an omega conopeptide. In one illustrative embodiment, the specialty drug comprises ziconotide.

In some embodiments, the method is implemented by a manufacturer of the specialty drug or by a partner, agent, or affiliate of the manufacturer of the specialty drug, or a combination of such manufacturer and such partner, agent, or affiliate. The single access point can be defined by the manufacturer of the specialty drug or by the partner, agent, or affiliate of the manufacturer of the specialty drug, or the combination of such manufacturer and such partner, agent, or affiliate. The partner, agent, or affiliate can include the pharmacy.

Some embodiments further include, by the computer hub, observing and analyzing trends in handling, ordering, patient adherence, and reimbursement of the specialty drug.

In some embodiments, the specialty drug is distributed to a single pharmacy, to the exclusion of all other pharmacies.

In some embodiments, the computer hub comprises a database.

In some embodiments, enrolling the physicians of the plurality of physicians comprises receiving from each physician an indicator of whether that physician selects Direct Bill or Buy and Bill.

Some embodiments further include receiving from enrolled physicians a plurality of enrollments for the corresponding patients.

Some embodiments further include referring the patient to a foundation for potential financial support, for example, if the patient is not enrolled in a commercial insurance plan. Referring the patient to the foundation can include, at the single access point, completing an application with the foundation on behalf of the patient.

In some embodiments, reducing the initial patient payment obligation includes applying a coupon towards the patient out-of-pocket requirement. Some embodiments further include limiting a total amount of savings that the patient may receive in a particular period of time.

Systems adapted to carry out any of such methods are also provided.

Under another aspect of the present invention, a system is provided for distributing a specialty drug with increased safety and reduced patient cost. The specialty drug may require specialized handling procedures and specialized prescription filling procedures. The system may include a computer hub operating at a single access point and configured to enroll a plurality of physicians and to permit the enrolled physicians to administer the specialty drug, to the exclusion of any other physicians. The system further may include a distribution location using the specialized handling procedures to distribute the specialty drug from the single access point to a pharmacy specifically educated in the specialized handling procedures and the specialized prescription filling procedures, for delivery from the pharmacy exclusively to enrolled physicians responsive to prescriptions by those enrolled physicians for corresponding patients. Any pharmacies that are not educated in the specialized handling procedures and the specialized prescription filling procedures may be excluded. Each prescription is for at least the specialty drug. At the single access point, for each prescription, responsive to that prescription, it is determined whether the patient is currently enrolled in a commercial insurance plan. Based upon the patient currently being enrolled in a commercial insurance plan, a patient out-of-pocket requirement of the commercial insurance plan is determined and compared to a capped payment amount. Based upon the patient out-of-pocket requirement exceeding the capped payment amount, a total invoice amount of the specialty drug divided by a total invoice amount of the prescription is calculated to obtain a percentage of the total invoice attributable to the specialty drug, the percentage is multiplied by the patient out-of-pocket requirement to obtain an initial patient obligation for only the specialty drug, and the initial patient obligation for only the specialty drug is reduced to the capped payment amount.

Under another aspect of the present invention, a system is provided for distributing a specialty drug with increased safety and reduced patient cost. The specialty drug may require specialized handling procedures and specialized prescription filling procedures. The system may include means operating at a single access point for enrolling a plurality of physicians and to permit the enrolled physicians to administer the specialty drug, to the exclusion of any other physicians. The system also may include means for using the specialized handling procedures to distribute the specialty drug from the single access point to a pharmacy specifically educated in the specialized handling procedures and the specialized prescription filling procedures, for delivery from the pharmacy exclusively to enrolled physicians responsive to prescriptions by those enrolled physicians for corresponding patients. Any pharmacies that are not educated in the specialized handling procedures and the specialized prescription filling procedures may be excluded. Each prescription is for at least the specialty drug. The system also may include means at the single access point, for each prescription, responsive to that prescription, for determining whether the patient is currently enrolled in a commercial insurance plan. The system also may include means for, based upon the patient currently being enrolled in a commercial insurance plan, determining a patient out-of-pocket requirement of the commercial insurance plan and for comparing the out-of-pocket requirement to a capped payment amount. The system also may include means for, based upon the patient out-of-pocket requirement exceeding the capped payment amount, calculating a total invoice amount of the specialty drug divided by a total invoice amount of the prescription to obtain a percentage of the total invoice attributable to the specialty drug, for multiplying the percentage by the patient out-of-pocket requirement to obtain an initial patient obligation for only the specialty drug, for reducing and the initial patient obligation for only the specialty drug to the capped payment amount.

Under another aspect of the present invention, a non-transitory computer-readable medium is provided that stores instructions for causing one or more processors at a single access point to distribute a specialty drug with increased safety and reduced patient cost. The specialty drug may require specialized handling procedures and specialized prescription filling procedures. The instructions may cause the one or more processors to perform steps that include enrolling a plurality of physicians and permitting the enrolled physicians to administer the specialty drug, to the exclusion of any other physicians. A distribution location uses the specialized handling procedures to distribute the specialty drug from the single access point to a pharmacy specifically educated in the specialized handling procedures and the specialized prescription filling procedures, for delivery from the pharmacy exclusively to enrolled physicians responsive to prescriptions by those enrolled physicians for corresponding patients. Any pharmacies that are not educated in the specialized handling procedures and the specialized prescription filling procedures may be excluded. Each prescription is for at least the specialty drug. At the single access point, for each prescription, responsive to that prescription, it is determined whether the patient is currently enrolled in a commercial insurance plan. Based upon the patient currently being enrolled in a commercial insurance plan, a patient out-of-pocket requirement of the commercial insurance plan is determined and compared to a capped payment amount. Based upon the patient out-of-pocket requirement exceeding the capped payment amount, a total invoice amount of the specialty drug divided by a total invoice amount of the prescription is calculated to obtain a percentage of the total invoice attributable to the specialty drug, the percentage is multiplied by the patient out-of-pocket requirement to obtain an initial patient obligation for only the specialty drug, and the initial patient obligation for only the specialty drug is reduced to the capped payment amount.

### BRIEF DESCRIPTION OF DRAWINGS

FIG. 1 is a block diagram depicting an environment where one or more pharmacies, physicians, and patients can interact with a computer hub operating at a single access point for limited distribution of a specialty drug with increased safety and reduced patient cost, according to some embodiments of the present invention.

FIG. 2 is a block diagram depicting a single general purpose computer environment wherein one or more pharmacies, physicians, and patients can interact with a computer hub operating at a single access point for limited distribution of a specialty drug with increased safety and reduced patient cost, according to some embodiments of the present invention.

FIG. 3 is a flowchart of an exemplary process that may be used to facilitate distribution of a specialty drug using a computer hub operating at a single access point with increased safety and reduced patient cost, according to some embodiments of the present invention.

FIG. 4 is a flowchart of an exemplary process that may be used to facilitate reductions in patient cost for a specialty drug using a computer hub operating at a single access point, according to some embodiments of the present invention.

FIG. 5 illustrates an exemplary communication that may be provided to a physician in association with reductions in patient cost for a specialty drug using a computer hub operating at a single access point, according to some embodiments of the present invention.

FIGS. 6A-6B illustrate an exemplary communication that may be provided to a patient or a physician in association with reductions in patient cost for a specialty drug using a computer hub operating at a single access point, according to some embodiments of the present invention.

FIGS. 7A-7C illustrate an exemplary communication that may be provided to a patient in association with reductions in patient cost for a specialty drug using a computer hub operating at a single access point, according to some embodiments of the present invention.

FIG. 8 illustrates an exemplary communication that may be provided to a patient in association with reductions in patient cost for a specialty drug using a computer hub operating at a single access point, according to some embodiments of the present invention.

FIG. 9 is a flowchart of an exemplary process for enrolling a new patient using a computer hub operating at a single access point, according to some embodiments of the present invention.

FIG. 10 is a flowchart of an exemplary process for refilling a prescription for a specialty drug using a computer hub operating at a single access point, according to some embodiments of the present invention.

FIG. 11 is a flowchart of an exemplary process for reducing patient costs for a specialty drug using a computer hub operating at a single access point, according to some embodiments of the present invention.

FIG. 12 is a flowchart of an exemplary process for wholesale distribution of a specialty drug using a computer hub operating at a single access point, according to some embodiments of the present invention.

FIG. 13 is a flowchart of an exemplary process for enrolling a new patient and reducing that patient's costs for a specialty drug using a computer hub operating at a single access point, according to some embodiments of the present invention.

FIG. 14 is a flowchart of an exemplary process for reducing patient costs for a specialty drug using a computer hub operating at a single access point, according to some embodiments of the present invention.

FIG. 15 is a flowchart of an exemplary process for reducing patient costs for a specialty drug using a computer hub operating at a single access point, according to some embodiments of the present invention.

### DETAILED DESCRIPTION

Embodiments of the present invention provide systems, methods, and computer-readable media for limited distribution of a specialty drug using a centralized distribution model, or “hub.” Such a model of distribution can yield enhanced safety in distributing and administering the drug, and also can provide the patient with significant cost savings. For example, all prescriptions for the specialty drug can be processed only using the computer hub and the single access point.

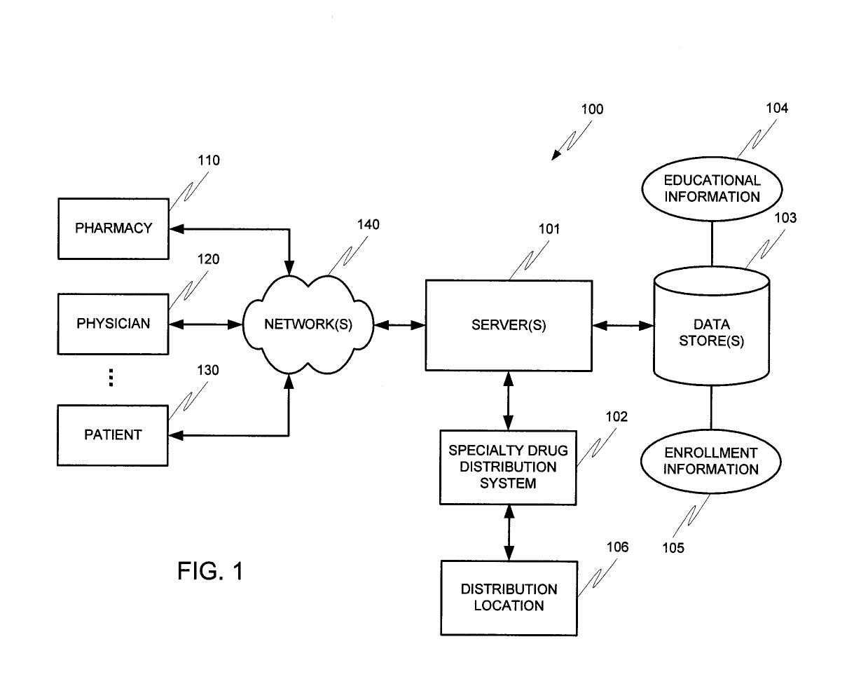

FIG. 1 depicts at 100 an environment wherein one or more pharmacies 110, physicians 120, and patients 130 can interact with a specialty drug distribution system 102 to achieve distribution of a specialty drug with increased safety and reduced patient cost. The one or more pharmacies 110, physicians 120, and patients 130 can interact with the system 102 through a number of ways, such as over one or more networks 140. Server(s) 101 accessible through the network(s) 140 can host the system 102. One or more data stores 103 can store the data to be analyzed by or distributed by the system 102 as well as any intermediate or final data generated by the system 102, e.g., educational information 104 and enrollment information 105. The one or more data stores 103 can include a database for storing the enrollment information 105. System 102 further can communicate with a distribution location 106 that is configured to distribute the specialty drug from the single access point only to the one or more pharmacies 110. Distribution location 106 can include one or more processors configured to receive orders for the specialty drug from system 102, and can be configured to prepare such orders for distribution to the one or more pharmacies using the specialized handling procedures for the specialty drug. Optionally, system 102 communicates with distribution location 106 via network(s) 140. Alternatively, system 102 and distribution location 106 can be co-located with one another.

In certain embodiments, specialty drug distribution system 102 operates at a single access point, that is, only under the control of a single entity, such as the manufacturer of the specialty drug, or any entity or combination of entities each of which are authorized by the manufacturer of the specialty drug, e.g., any suitable combination of partners, agents, or affiliates of the manufacturer of the specialty drug. Such an arrangement may facilitate the manufacturer's ability to maintain sufficient safety and cost controls over the specialty drug. In particular, system 102 can be used to limit all prescriptions of the specialty drug to be exclusively issued by enrolled physicians, exclusively for enrolled patients, and to be exclusively filled by the one or more pharmacies. In one illustrative embodiment, server(s) 101, specialty drug distribution system 102, and data store(s) 103 may be utilized as a hub, or a portion thereof, operating at a single access point. Note, however, that server(s) 101, specialty drug distribution system 102, and data store(s) 103 need not necessarily be co-located with one another, so long as server(s) 101, specialty drug distribution system 102, and data store(s) 103 ultimately are operated under the control of a common entity or any suitable combination of partners, agents, or affiliates of that entity.

In one exemplary embodiment, the computer hub operates at a pharmacy that is affiliated or partnered with the specialty drug manufacturer. That is, the pharmacy may define all or a portion of a single access point. Such a configuration may provide further efficiencies, product safety, and patient cost reduction because the hub can facilitate the pharmacy's receipt and processing of physician and patient enrollment information, communicating with the physician and patient, determining patient benefits and reducing patient payment obligations, submitting claims to insurance as appropriate, billing the physician as appropriate, requesting reimbursement from the specialty drug manufacturer for patient payment discounts that the pharmacy may apply, and filling and delivering prescriptions for the specialty drug with an increased level of education and safety. Additionally, such a configuration can provide the advantage that information may be transmitted among the hub/pharmacy and the physician more quickly and using less bandwidth, fewer computer resources, and fewer steps than would be needed to communicate information amongst three parties, e.g., amongst a hub and a pharmacy, amongst the hub and a physician, and amongst the pharmacy and the physician. In one illustrative embodiment, the pharmacy is the only entity authorized by the drug manufacturer to distribute the specialty drug. The pharmacy can operate distribution location 106 illustrated in FIG. 1.

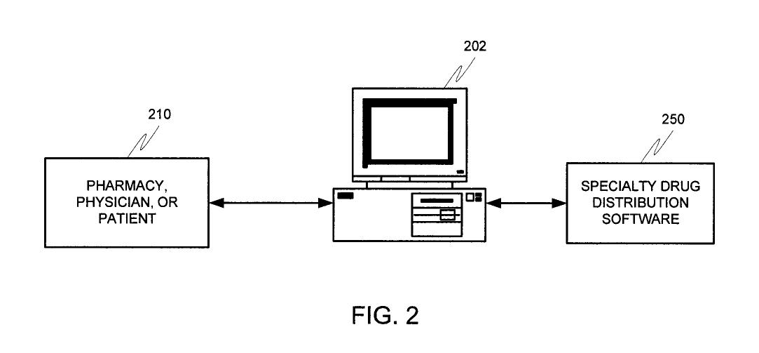

Specialty drug distribution system 102 can be an integrated web-based reporting and analysis tool that provides one or more pharmacies 110, physicians 120, and patients 130 flexibility and functionality for distributing a specialty drug, such as ziconotide, with increased safety and reduced patient cost. Specialty drug distribution system 102 can include, or can be in operable communication with, a non-transitory computer-readable medium storing instructions for causing system 102 to perform all or a portion of one or more of the methods described herein. It should be understood that the system 102 could also be provided on a stand-alone computer for access by one or more pharmacies, physicians, or patients. In one illustrative embodiment, FIG. 2 is a simplified block diagram of a computer system 202, such as a personal computer for implementing at least a portion of the methods described herein. The computer system 202 includes a central processing unit (CPU) (not specifically illustrated) executes computer programs, including specialty drug distribution software 250, stored on a memory (not specifically illustrated). The memory in one embodiment comprises one or more levels of cache as desired to speed execution of the programs and access to data on which the programs operate. The CPU is directly coupled to the memory in one embodiment. In addition to the CPU and memory which are coupled to a bus, computer system 202 further may include storage, I/O, and communications that also are coupled to the bus (components of computer system 202 not specifically illustrated). The storage is usually a long term storage device, such as a disk drive, tape drive, DVD, CD or other type of storage device. In one embodiment, the storage is used to house a database for use with the present invention. The I/O comprises keyboards, sound devices, displays and other mechanisms by which one or more pharmacies, physicians, or patients 210 interact with the computer system 202. The communications comprises a network, phone connection, local area network, wide area network or other mechanism for communicating with external devices. Such external devices comprise servers, other peer computers and other devices. In one embodiment, such external device comprises a database server that is used in place of the database on the storage of computer 202. Other computer system architectures capable of executing software and interacting with a database and users may also be used. Appropriate security measures such as encryption are used to ensure confidentiality. Further, data integrity and backup measures are also used to prevent data loss.

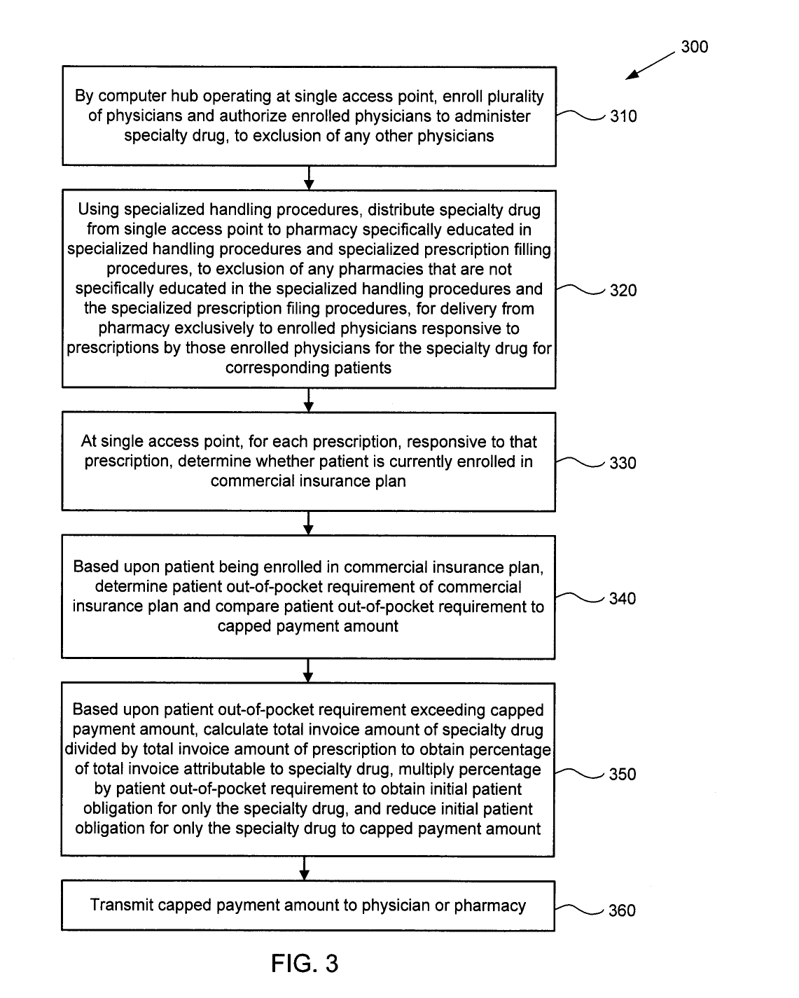

FIG. 3 is a flowchart of an exemplary process flow 300 that may be used to facilitate distribution of a specialty drug using a computer hub operating at a single access point with increased safety and reduced patient cost. In an exemplary embodiment, the specialty drug is of such a nature that it requires specialized handling procedures, specialized prescription filling procedures, and specialized administration procedures. For example, as described herein, specialty drugs for intrathecal administration can have heightened handling, prescription filling, and administration procedures so as to reduce the risk of inadvertently introducing any infectious agents or foreign substances. Additionally, the handling, prescription filling, and administration procedures may be even more critical for certain specialty drugs such as omega conopeptides. For example, as described elsewhere herein, ziconotide must be handled within a particular temperature range and must be properly buffered; ziconotide prescriptions must be filled with particular care, particularly if the ziconotide is to be compounded or co-administered with another drug. The present systems, methods, and computer-readable media can enhance safety for such specialty drugs by limiting distribution of the drug only to pharmacies that are specifically educated in proper handling and prescription filling procedures for the drug, for delivery only to enrolled physicians. Additionally, the present systems, methods, and computer-readable media can reduce patient cost for such specialty drugs by applying certain discounts to the patient's out-of-pocket costs for patients enrolled in a commercial insurance plan, that is, having commercial insurance coverage, or otherwise facilitating other funding sources for the patient, as described in greater detail herein.

Process flow 300 illustrated in FIG. 3 includes, by a computer hub operating at a single access point, enrolling a plurality of physicians and permitting the enrolled physicians to administer the specialty drug, to the exclusion of any other physicians (step 310). For example, as noted above with reference to FIG. 1, server(s) 101, specialty drug distribution system 102, and data store(s) 103 be used as a hub, or a portion thereof, operating at a single access point. Specialty drug distribution system 102 may include, or may be in communication with, a non-transitory computer-readable medium, that includes instructions causing system 102 to receive information from a plurality of physicians who desire to prescribe and administer a specialty drug, such as ziconotide, to their respective patients, and to enroll such physicians to the hub, e.g., to record such physicians as being permitted to prescribe and to administer the specialty drug. The information received from the enrolled physicians also can include an indicator of the physician's billing selection, for example whether the physician selects Direct Bill or Buy and Bill, such as described in greater detail below. The information received from the enrolled physicians can be entered into data store 103 using any suitable method or interface. By providing the feature of centrally enrolling physicians and receiving and storing the enrolled physicians' information by a computer hub operating at a single access point, the advantage is reached that fewer discrete computer resources are needed to receive and store such information. For example, a centralized database can be used to receive and store the information, rather than multiple, unrelated databases each of which would require its own memory and lines of communication.

Referring again to FIG. 3, process flow 300 further includes, using the specialized handling procedures, distributing the specialty drug from the single access point to a pharmacy that is specifically educated in the specialized handling procedures and specialized prescription filling procedures, to the exclusion of any pharmacies that are not educated in the specialized handling procedures and the specialized prescription filling procedures, for delivery from the pharmacy exclusively to enrolled physicians responsive to prescriptions by those enrolled physicians for the specialty drug for corresponding patients (step 320). The prescription is for at least the specialty drug, and also may be for additional drugs to be co-administered, e.g., compounded or admixed, with the specialty drug. In certain embodiments, only a single pharmacy, or a relatively low number of pharmacies (e.g., two or three pharmacies) may have sufficient education in the handling and prescription filling of the specialty drug so as to be permitted to receive the specialty drug (e.g., from the single access point) and to fill prescriptions of the specialty drug. In addition to the specific education requirements, the one or more pharmacies also may be required to be accredited or certified by the Accreditation Commission for Heath Care (ACHA) or the Pharmacy Compounding Accreditation Board (PCAB), or both, particularly for embodiments in which the specialty drug is for intrathecal administration and is to be compounded with another drug. In one illustrative embodiment, specialty drug distribution system 102 may include, or may be in communication with, a non-transitory computer-readable medium, that includes instructions causing system 102 to transmit an order for the specialty drug to distribution location 106, which receives the order and then distributes the order to the pharmacy. The order may be for the prescription, or may be for an amount that is greater than the prescription. After receiving the prescription for the specialty drug from one of the enrolled physicians and receiving the order from the distribution location, the pharmacy may fill the prescription using the specialized prescription filling procedures and may deliver the filled prescription exclusively to that enrolled physician using the specialized handling procedures. That physician then may administer, e.g., intrathecally administer, to the patient the delivered, filled prescription.

Referring again to FIG. 3, process flow 300 further includes, at the single access point, for each prescription, responsive to that prescription, determining whether the patient is currently enrolled in a commercial insurance plan, that is, whether the patient has commercial insurance coverage (step 330). For example, specialty drug distribution system 102 illustrated in FIG. 1 may include, or may be in communication with, a non-transitory computer-readable medium, that includes instructions causing system 102 to receive information about patients to which the specialty drug is to be administered. The patient information can include current information about whether the patient is enrolled in a commercial health plan. In one illustrative embodiment, such patient information is collected by the physician, and the physician then submits that information to the computer hub. The computer hub then may enroll the patient, e.g., may record such patient as being permitted to receive prescriptions of and administrations of the specialty drug. The instructions further may cause system 102 to analyze the information for enrolled patients, and to determine based on such analysis whether a given patient is currently enrolled in a commercial insurance plan. For example, responsive to receipt of the prescription, the single access point may contact the patient's commercial insurance company to obtain the patient's current insurance status. Such contacting may be via any suitable mode of communication.

Referring again to FIG. 3, process flow 300 further includes, based upon the patient being enrolled in a commercial insurance plan, determining a patient out-of-pocket requirement of the commercial insurance plan and comparing the patient out-of-pocket requirement to a capped payment amount (step 340). For example, when the single access point may contact the patient's commercial insurance company to obtain the patient's current insurance status, the single access point further may obtain current information about any patient out-of-pocket requirement of that plan. The capped payment amount can be any suitable amount, e.g., can be a dollar amount that is set lower than the out-of-pocket requirement of a majority of patients, so that the majority of patients may benefit from a reduction in their out-of-pocket expenses for the specialty drug in a manner such as described further herein. Exemplary capped payment amounts can be, for example, $10, or $20, or $25, or $30, or $40, or $50, or any suitable amount in currencies other than the dollar.

Process flow 300 illustrated in FIG. 3 further includes, based upon the patient out-of-pocket requirement exceeding the capped payment amount, calculating the total invoice amount of the specialty drug divided by the total invoice amount of the prescription to obtain a percentage of the total invoice that is attributable to the specialty drug multiplying the percentage by the patient out-of-pocket requirement to obtain an initial patient obligation for only the specialty drug, and reducing the initial patient obligation for only the specialty drug to the capped payment amount (step 350). In one illustrative example, specialty drug distribution system 102 illustrated in FIG. 1 may include, or may be in communication with, a non-transitory computer-readable medium that includes instructions causing system 102 to determine the capped payment amount based on the total invoice amount of the specialty drug, the total invoice amount for the prescription (which may be greater than the total invoice amount of the specialty drug, if the specialty drug is prescribed to be co-administered or compounded with another drug), the patient out-of-pocket requirement, and the capped payment amount. In one illustrative embodiment, the initial patient obligation for only the specialty drug is reduced by applying a coupon towards the patient out-of-pocket requirement of the commercial insurance plan. Additionally, or alternatively, the total amount of savings that the patient may receive in a particular period of time may be limited.

Referring again to FIG. 3, process flow 300 includes transmitting the capped payment amount to the physician or the pharmacy (step 360). For example, specialty drug distribution system 102 illustrated in FIG. 1 may include, or may be in communication with, a non-transitory computer-readable medium that includes instructions causing system 102 to transmit a text-based representation of the capped payment amount to the physician or to the pharmacy, or both, via any suitable mode of communication, e.g., by facsimile or email. By providing the feature of pre-calculating the capped payment amount using steps 330-350 and then transmitting the capped payment amount to the physician or pharmacy, the advantage is reached that the transmission of information to the physician or the pharmacy is faster and uses less bandwidth than a transmission that would include all of the information that had been used to pre-calculate such a capped payment amount.

Note that steps 330-360 illustrated in FIG. 3 may be performed responsive to the physician issuing a first prescription for the specialty drug for a given patient, and also may be performed each time that the physician issues a refill of that prescription. Such repeated re-calculation of capped payment amounts may be particularly appropriate for specialty drugs that frequently are co-administered with other drugs, e.g., omega conopeptides such as ziconotide that frequently are compounded with other drugs. For example, although a manufacturer may wish to provide a patient discount for the specialty drug by reducing the patient's obligation to a capped payment amount, it may be undesirable or inappropriate for any portion of that discount to apply to another drug that is co-administered with the specialty drug. The relative costs of each drug may vary over time, so even if a given prescription is refilled identically to a previous prescription, the percentage of the total invoice attributable to the specialty drug may vary between the earlier prescription and the refill, potentially resulting in a change in the initial patient obligation for only the specialty drug, and thus to the difference between the initial patient obligation and the capped payment amount. Changes to the prescription itself, e.g., to the amounts of the specialty drug and any other drug, also may result in a change in the initial patient obligation for only the specialty drug, and thus to the difference between the initial patient obligation and the capped payment amount. Changes to the patient's insurance plan or out-of-pocket requirement also may result in a change in the initial patient obligation for only the specialty drug, and thus to the difference between the initial patient obligation and the capped payment amount. By calculating the initial patient obligation responsive to each prescription, whether it be a refill or a new prescription, the patient may receive a reduction in patient obligation for only the specialty drug that is accurately based on the amount of the specialty drug in that particular prescription and the current costs of the specialty drug and any other drugs in the prescription. For further information about co-administering ziconotide with other exemplary drugs, see U.S. Pat. Nos. 8,268,744 and 8,650,033, the entire contents of each of which are incorporated by reference herein.

Optionally, based upon the patient not being enrolled in a commercial insurance plan, e.g., having no insurance coverage, or being publically insured, the patient may be referred to a foundation for potential financial support. For example, specialty drug distribution system 102 illustrated in FIG. 1 may include, or may be in communication with, a non-transitory computer-readable medium, that includes instructions causing system 102 to populate an online application to the foundation with appropriate information from the received patient information, and to submit the application to the foundation on the patient's behalf. The referral may be performed using any suitable method. The hub also may facilitate making available to the patient other patient assistance programs or alternative funding sources as appropriate, such as described herein.

It should be understood the steps and the order of the steps in FIG. 3, as well as in the various other flowcharts described herein, may be altered, modified, removed and/or augmented and still achieve the desired outcome. A multiprocessing or multitasking environment could allow two or more steps to be executed concurrently.

In certain embodiments, the present systems, methods, and computer-readable media further may provide the information about specialized handling procedures, specialized prescription filling procedures, or specialized administration procedures for the specialty drug to the pharmacy or the physician as appropriate. For example, the computer hub may provide information about the specialized handling procedures to the pharmacy, such as instructions for just in time delivery of the specialty drug and for refrigerating the specialty drug so that the drug remains refrigerated throughout distribution and is not frozen. Or, for example, the computer hub may provide information about the specialized prescription filling procedures to the pharmacy, such as instructions for preparing the prescription of the specialty drug exclusively for the patient, rather than as a portion of a batch that is prepared for multiple patients and divided, or instructions for admixing the specialty drug by the pharmacy with another drug. Or, for example, the computer hub may provide information about specialized administration procedures to the physician, such as instructions for admixing the specialty drug by the physician with another drug, or instructions for intrathecally administering the specialty drug via a bolus injection, an intermittent pulse, or a continuous infusion, or one or more of estimated intrathecal pump refill timing, intrathecal pump marketplace warnings, intrathecal pump compatibility, and methods of using the specialty drug in different intrathecal pumps. Such information can be provided to the pharmacy or to the physician via any suitable mode of communication.

In comparison to the highly centralized distribution of specialty drug using a pharmacy that is highly trained in handling and prescription filling of that drug such as provided herein, conventional distribution of pharmaceuticals typically is through retail pharmacies. There are thousands of different retail pharmacies and each pharmacy must learn the specifics of the handling requirements for each pharmaceutical. Shipping and distribution of certain specialty drugs, particularly drugs for intrathecal (IT) administration, such as full vials of ziconotide (commercially available under the trade name PRIALT®), can require refrigeration and the above-mentioned specifics. The level of sophistication and knowledge needed for handling increases dramatically if the specialty drug, e.g., ziconotide, is combined or admixed with another intrathecal agent. This is known as ‘high-risk compounding’ that should only be performed at trained, ACHA/PCAB certified compounding pharmacies. For example, although compounding or admixing ziconotide with other IT agents has not been well studied and is not recommended in ziconotide's package insert, clinical practice can include compounding or admixing as often or more often than dispensing whole ziconotide vials for monotherapy use per the product package insert. There are hundreds of compounding pharmacies in the US, covering a broad range of quality and skill levels. Recent issues of meningitis and poor quality standards at some compounding pharmacies has raised the visibility of the level of risk presented by compounding and the lack of consistent quality procedures and results at many compounding pharmacies.

Compounding of specialty drugs for intrathecal administration, such as ziconotide, is among the highest risk types of compounding, as it often includes taking non-sterile opioids and combining them with ziconotide under sterile procedures and conditions. In the case of ziconotide, these ‘high risk compounding’ prescriptions are compounded/prepared, shipped to the physician's office, stored at the physician's office, then injected directly and continuously into a patient's cerebral spinal fluid (CSF). This is a significantly higher risk compounding method than other injections as intramuscular, subcutaneous, and even intravenous injections enter the body where the immune system can be employed to attack any infectious agents or foreign substances. There is no immune system in the CSF. If improper compounding technique is used and the preparation becomes infected or impure, these impurities are injected directly into the CSF with no opportunity for the immune system to respond. Thus it is critical that pharmacies handling and compounding IT admixtures have excellent quality and expertise. As provided herein, systems, methods, and computer-readable media for limiting the distribution and pharmacy services for specialty drugs, particularly drugs for intrathecal administration, such as ziconotide, improves product-specific knowledge and consistency in product handling and compounding/admixture and helps ensure that the drug, e.g., ziconotide, product remains stable/viable.

In one exemplary embodiment, the specialty drug, e.g., ziconotide is administered in a clinic, hospital or physician's office (which may be referred to herein as an MDO or facility) and data regarding administration of the product is submitted via a claim to insurance in the same way other medical procedures or activities are billed. Conventional pharmaceuticals (pills and oral solution) are delivered to patients through retail pharmacies. Retail pharmacy distribution allows collection of extensive data on the dose of drug dispensed, timing of obtaining refills, etc. This type of data is not possible or documented with drugs that are administered in the physician's office. Limiting distribution and pharmacy services for a specialty drug, e.g., ziconotide, allows centralized data collection and data capture, which in turn reduces the amount of required computing resources such as memory and bandwidth. For example, trends in product handling, ordering, patient adherence, and reimbursement for the specialty drug, e.g., ziconotide, can be observed and analyzed and programs, processes and changes can be instituted to address any issues or negative trends that are observed. For example, the present computer hub may observe and analyze trends in handling, ordering, patient adherence, and reimbursement of the specialty drug. Such trends can be aggregated and transmitted back to the drug manufacturer on a periodic basis, providing the advantage of reducing the amount of bandwidth and memory that otherwise would be needed to process such information on a non-aggregated basis.

Compounding pharmacies may charge mark-ups on the products used in their compounding admixtures and charge compounding/admixture fees. There are few if any controls or limits on the mark-ups that can be charged. There is a wide range of different prices for the same products and activities performed at one compounding pharmacy vs. another compounding pharmacy. Centralizing distribution and pharmacy services for a specialty drug, e.g., ziconotide, can increase consistency in pricing of the drug, e.g., ziconotide, to the physicians and can eliminate significant price variance to the patient and to payors, e.g., commercial insurance companies.

For certain types of specialty drugs, e.g., ziconotide, stability varies greatly depending on the vial concentration, product admixed with it and dose of the drug, e.g., ziconotide, and dose of the admixed product. Conventional pharmacies are not currently communicating the estimated stability of such specialty drugs, e.g., ziconotide, even in general terms. As provided herein, limiting distribution and pharmacy services of such specialty drugs, e.g., ziconotide, allows increased product-specific knowledge at the pharmacies, and educational tools can be consistently employed notifying physicians and healthcare professionals on best handling methods for the drug, e.g., ziconotide, patient and prescription-specific stability and estimated pump refill timing, updated product or IT pump marketplace warnings, pump compatibility, and methods of the drug, e.g., ziconotide, use in different intrathecal pumps. See U.S. Ser. No. 13/791,715, now U.S. Pat. No. 8,653,033, which is incorporated by reference herein in its entirety.

There are examples of drug distribution networks. For example see the following patent publications which are hereby incorporated by reference in their entireties: Moradi 2004/0019794, Lilly 2004/0176985, Califano 2003/0033168, Melker 2002/0177232, Borsand 2003/0074225, and Keresman 2001/0047281. Issued US patents that are relevant and incorporated by reference include Reardon U.S. Pat. No. 7,765,106 and Medvitz U.S. Pat. No. 8,666,778.

In one embodiment of the invention, the drug to be distributed is an omega conopeptide, e.g., ziconotide. See the following patents which are hereby incorporated by reference in their entireties: U.S. Pat. Nos. 5,189,020; 7,268,109; 7,977,307; 7,956,030; 5,587,454; 6,054,429; and 5,891,849.

In certain embodiments, a drug distribution system and method utilizes a small number of central pharmacies, or even a single pharmacy, and a central database to track all prescriptions for a drug. Information is kept in a central database, e.g., at the computer hub, regarding the physicians allowed to prescribe the sensitive drug, and all patients receiving the drug.

In one embodiment, education is provided to the physician, such as by the pharmacy. One example of the educational material can be the stability of the drug when admixed with other agents.

The computer hub can be used to provide educational materials to doctors regarding the drug, to provide an educated pharmacy work staff who have intimate knowledge on how to handle the specific drug and advice on reimbursement for the drug.

Opioids, omega conopeptides such as ziconotide, and other drugs have been provided for analgesia alone and in combination with other intrathecal treatments to treat a variety of conditions including but not limited to spasticity and/or severe chronic pain due to cancer, failed back syndrome, complex regional pain syndrome (CRPS), neuropathic pain, nociceptive pain, mixed neuropathic and nociceptive pain, etc. This administration can be by an implantable pump that provides continuous infusion. It has been found that the admixture of multiple products in a single chamber of a pump can cause corrosion in some pumps. Pump corrosion can cause motor failure and can even lead to death. Single chamber pumps also have only one flow rate, so admixtures of multiple drugs cannot easily be adjusted for the appropriate flow rate and dose of each drugs. When adverse effects occur, the dose of the offending agent needs to be reduced. With single-chamber pumps, the concentration of the non-offending drug would need to be increased to make up for the reduction in flow rate of the offending drug. This is not always possible and is complicated to perform. See U.S. Provisional Application No. 61/806,084 which is hereby incorporated by reference in its entirety.

Omega Conopeptides

Omega conopeptides, also known as omega conotoxins, are a class of specialty drug that includes a group of small (24-29 amino acids), disulfide-rich polypeptides, found in the venoms of predatory marine snails that belong to the genus Conus. All omega conopeptides bind to N-type voltage sensitive calcium channels (VSCC), which are found exclusively in neurons, although the binding affinities for specific VSCC subtypes may differ. In response to nerve cell membrane depolarization, N-type VSCCs open and permit calcium entry that results in neurotransmitter release. N-type VSCCs are abundant in the Rexed laminae I and II of the dorsal horn of the spinal cord, where primary afferent fibers in the pain signaling synapse for the first time. Omega conopeptides bind to N-type VSCCs in the Rexed laminae I and II and blocks calcium transport into the presynaptic terminal, thereby blocking neurotransmitter release. By blocking calcium entry at N-type VSCCs in this location, pain signals, including those that develop after peripheral nerve injury and characterize peripheral neuropathies, are less easily transmitted or are blocked completely.

An exemplary omega conopeptide useful for this invention is ziconotide, which is available commercially under the trade name PRIALT®. Ziconotide (SNX-111), a 25-amino acid peptide, is a synthetic version of a naturally-occurring peptide found in the venom of the marine snail Conus magus. Ziconotide specifically and selectively binds to VSCCs.

Omega Conopeptides and Treatment of Chronic and Neuropathic Pain

Treatment with omega conopeptides, such as ziconotide, is useful in preventing progression of neuropathic pain. Analgesic omega conopeptides are effective as analgesic agents both in traditional opiate-sensitive models of nociceptive pain, such as the Rat Tail-Flick model or the rat formalin model, as well as in opiate-resistant models of pain, such as allodynia model of neuropathic pain.

Ziconotide has a unique combination of pharmacological actions. Specifically, intrathecally-administered ziconotide is more potent, longer acting, and more specific in its actions than are traditional neuropathic pain targeting drugs such as morphine or clonidine.

Ziconotide is used to treat severe chronic pain such as neuropathic pain. Ziconotide, unlike morphine, does not suppress respiratory function and does not have addiction potential. Once a therapeutic dose is reached, tolerance does not appear to develop as it does with opioids. Ziconotide is effective in both non-neuropathic (visceral, somatic) and neuropathic cancer pain and in non-malignant neuropathic pain states. Co-administration with an opioid, such as morphine, may reduce opioid induced hyperalgesia.

Stability of Ziconotide

Dilute solutions of omega conopeptides are generally unstable in solution, as evidenced by oxidation of methionine residues and reduction or loss of biological activity. In particular, ziconotide, which contains a methionine at position 12, is approximately 10-fold less potent in binding to omega conopeptide MVIIA binding sites when its methionine is present in the sulfoxy form. Omega conopeptides can, however, be significantly stabilized in solution by preventing oxidation of methionine residues present in the peptide structure. Ziconotide oxidation, for example, can be prevented by addition of lactate buffer to the composition. More particularly, buffers containing 150 mM lactate buffer, pH 4-4.5 improve stability of the compound considerably. Solutions of ziconotide in which the peptide concentration is less than about 0.1 mg/ml oxidize rapidly when dissolved in water, saline, or any of a number of buffers used in the art of peptide chemistry. Solutions of ziconotide ranging from 0.01-0.1 mg/ml are stable at 45° C. for weeks when stabilized with lactate (150 mM, ph 4-4.5). Buffers containing 50 μg/ml methionine are also effective in stabilizing ziconotide when either 150 mM lactate buffer or acidified saline (pH 4-4.5) is used to buffer the solution. See Examples 2 and 3 and Tables 2 and 3 from U.S. Pat. No. 7,268,109.

The pharmaceutical formulations of certain embodiments of the present invention are suitable for intrathecal administration, particularly continuous intrathecal infusion. An exemplary formulation is stable in a drug dispensing implantable pump at 37° C. for at least 14 days, or at least 21 days, or at least 28 days, or at least 35 days, or at least 42 days, or at least 49 days, or at least 60 days, or at least 90 days.

Systems, Methods, and Computer-Readable Media for Treating Patients Including Reducing Pain

Embodiments of the present invention provide systems, methods, and computer-readable media for reducing pain, potentially severe chronic pain, in a patient. The method can include administering to a patient an effective amount of a specialty drug, such as an omega conopeptide. The specialty drug can be delivered to the patient using a centralized distribution model, or computer hub, which can facilitate increased safety in handling and reduced cost to the patient, and reduced amount of computing resources needed to share information amongst the hub, the pharmacy, and the physician.

The pharmaceutical formulation can be administered in a variety of routes of administration, including but not limited to regional or systemical, parenteral, subcutaneous, intraperitoneal, intravascular, perineural, epidural, and most particularly, intrathecal. Intrathecal delivery of drugs can be done by a bolus injection, intermittent pulse, or a continuous infusion. A bolus injection is defined as the injection of a drug (or drugs, also referred to as compounds) at once. Intermittent pulse involves bolus doses delivered through the pump. Continuous infusion is defined as the administration of a drug or drug combination continuously over a prolonged period of time. It can be at a constant flow rate or variable flow rate.

The formulations may be created in a variety of ways, depending upon the intended manner of introduction. The concentration of each drug in the drug formulation depends upon the route of administration. Generally, dosages and routes of administration of the compounds are determined according to the site of the pain and the size of the subject, according to standard pharmaceutical practices. Drug concentration may vary to increase the dose for a given flow rate. For example, a starting dose may be increased by refilling an intrathecal pump with a high concentration of an active ingredient for use at the same flow rate or a lower flow rate. Lower volumes and flow rates may be advantageous to reduce or eliminate negative side effects of intrathecal ziconotide administration, such as dizziness, mental confusion and so forth. See the PRIALT® product insert. Without wishing to be bound by theory, it is believed higher volumes or flow rates may drive a specialty drug, such as ziconotide, up into the brain from the point of intrathecal administration. Higher concentrations and low flow rates could potentially keep the specialty drug, such as ziconotide, limited to the injection site.

A therapeutically effective dose is an amount effective to produce a significant reduction in a condition such as chronic or neuropathic pain. The dose levels can be estimated for new compounds, by comparison with established effective doses of known compounds with structural similarities, taking into consideration predicted variations in bioavailability, biodistribution, and other pharmacokinetic properties, as can be empirically determined by persons skilled in the art. It is contemplated that dosages of drugs used in combination drug therapy are the same or lesser concentration than the concentration of each drug when administered alone by the same route of administration.

Drugs may be started at a low level and titrated upward to achieve the proper level of pain relief. Therapeutic effect will be discussed with reference to pain relief, however, other treatments are also contemplated (like spasticity for baclofen). Also, a patient may be transitioned from a higher dose of a compound such as morphine, to a lower dose using the pump and its ability to vary the concentration or the dose downward. Transitioning to a lower dose allows “weaning” from a particular compound, such as morphine for example.

Intrathecal infusion can be administered via an implantable pump. There are multiple types of pumps that are commercially available, such as the SYNCHROMED® infusion pump (commercially available from Medtronic, Inc., Neuromodulation, Minneapolis, Minn.), the CODMAN® 3000 infusion system (commercially available from DePuy Synthes Companies of Johnson & Johnson, Raynham, Mass.), the PROMETRA® programmable pump (commercially available from Flowonix, Mt. Oliver, N.J.), and others. In one embodiment, the present invention includes the separation of two compounds and their intrathecal administration. In one embodiment, the invention includes the use of a dual chamber pump.

In one embodiment, the systems, methods, and computer-readable media of the present invention provide enrollment for physicians at a single access point for a specialty drug, such as ziconotide, help address high patient out-of-pocket copays, and help reduce financial barriers to practices. Such systems, methods, and computer-readable media also can provide a simplified ordering process, reduced computer resources for transmitting information amongst the hub, pharmacy, and physician, and can include financial assistance services that may help lower out-of-pocket costs, and consistent pricing for the specialty drug, e.g., ziconotide.

An example physician enrollment form can contain one or more of the following items: Date: Facility, Facility Type: Hospital Outpatient/ASC Physician Office; PHS (ID#); FSS/OGA Other; Facility NPI #; Facility DEA #; Facility License #; Facility Tax ID#; Facility Contact; Facility Phone; Facility Fax; Clinical Contact; Phone; Fax; Email; Shipping Address; City; State; Zip Code; Billing Contact, such as Phone; Fax; Email; Shipping Address; City; State; Zip Code; Prescriber & Specialty Email; Prescriber; NPI #; DEA #; Medical License #; state license; and Federal Tax ID #. Completion of the enrollment form can be used for a comprehensive financial assessment of the physician in advance of enrolling the physician and permitting the physician to order the specialty drug, such as ziconotide.

In one embodiment, the physician (or a representative thereof, e.g., hospital, ambulatory surgery center (ASC), or clinic, which may be referred to herein as an MDO or facility) enrolls in the hub by completing the site enrollment form. Then, they can fill out a patient enrollment form that also functions as a prescription, including dose, patent name, insurance information, etc. The patient enrollment form can include, for example, pump type, concomitant medications, and other important medical information for that patient. Then, the hub will contact, e.g., call, the insurance carrier to explain the prescription to evaluate the insurance coverage, to determine whether a direct bill option is available (where the pharmacy can bill the insurer on behalf of the physician), and to determine the patient out-of-pocket requirement, as well as the comparison between buy and bill versus direct bill. They will also seek to understand how an insurer will reimburse the physician for buy and bill. Based on the information obtained by the program operator, and the out-of-pocket requirement that the patient may have, the patient may be referred to a Patient Foundation for potential assistance at this time. The financial information is then presented to the physician on an Insurance Verification Outcome (IVO) form. The physician determines if ziconotide is still appropriate for the patient, selects the billing method, and returns the IVO as the order, specifying a date that the drug is required. If the provider selects Direct Bill as the billing method for the patient, the pharmacy will take care of all drug invoicing and claims submission to the payer on behalf of the physician.

In one embodiment, buy and bill can, in some respects, be more complex than direct bill as it can require more staff and more expertise to submit and follow up on reimbursement claims. Buy and bill also can require the physician to bear the carrying costs of the drug and waiting for reimbursement as well as the risk of denial of reimbursement. However, some physicians still choose to use this method as there are advantages. Direct billing can remove some of this financial risk to the provider, and can simplify the administrative burden of the claims submission process. One advantage of the present invention is that the physician can compare either method (direct Bill vs. buy and bill), insurance coverage, and payment details. This helps to increase reimbursement confidence before the decision to move forward with the prescription is ever made.

In another embodiment, financial assistance is offered to those who need additional resources. This process is referred to as the Financial Assistance process, and utilizes a patient foundation for support (e.g., Caring Voice Coalition). This process involves an online enrollment and referral process between the foundation and the hub. In one exemplary embodiment, once a patient is identified as potentially eligible, the hub will complete an online application with the foundation, and the patient will be temporarily accepted based on further review. During this time, the communication to the provider office includes a “TBD” in the patient out-of-pocket amount, and notes will include that the assistance is pending review for the patient. If the foundation accepts the patient, and commits a grant, the foundation acceptance is then communicated to the provider office with a second follow up IVO.

For those patients that are identified as uninsured or underinsured (no coverage for ziconotide), the patient then may qualify for the Patient Assistance Program (PAP) or alternative funding.

For patients that have commercial insurance, another program, which may be referred to herein as the “Savings Program,” can be administered by the hub. The Savings Program will identify patients that have commercial insurance, and automatically apply a copay/coinsurance coupon towards their out-of-pocket amount. Regardless of how the specialty drug, e.g., ziconotide, is prescribed, a commercially insured patient should not have to pay more than a capped out-of-pocket amount, e.g., not more than $20, attributable to the amount of specialty drug, e.g., ziconotide, in the prescription. If there is more than one drug included in the prescription, the program will apply a formula that calculates the total invoice amount of specialty drug, e.g., ziconotide, divided by the total invoice amount of the entire prescription. This percentage attributed to the specialty drug, e.g., ziconotide, is then applied towards the patient's out-of-pocket amount as determined by the insurance verification process. This new out-of-pocket amount can be communicated to the physician, e.g., on the IVO form. Optionally, the Savings Program may cap the total amount of savings that a patient may receive in a particular period of time, e.g., in a particular calendar year. Patients that are publically insured, or that wish to not participate, or those that do not qualify for this program, can be referred to the Patient Foundation, patient assistance program, or alternative funding for potential assistance.

Reimbursement support is also offered by the hub. Physicians, or representatives thereof, can reach out to staff associated with the hub to request assistance in identifying the appropriate billing and coding methods, including appropriate codes to utilize per published payer guidelines, for example.

In another embodiment, educational material may be sent to the physician to provide information on the drug stability. For example, as shown in U.S. Ser. No. 13/791,715, the stability of ziconotide can be affected if combined with additional drugs. The educational material can contain graphs, charts or other representations that indicate the stability profile of the specialty drug, e.g., ziconotide, under certain circumstances, such as admixture, temperature, time, and any other typical circumstances which affect the drug composition. Alternatively, an on-staff pharmacist will directly contact the physician via telephone to have a clinical discussion and educate them on stability tables to ensure understanding and proper dosing.

In one exemplary implementation, the Savings Program can be configured to implement business rules such as the following, for example when executing steps 330-350 of flowchart 300 illustrated in FIG. 3:

The Savings Program is limited to commercially insured patients only;

The Savings Program excludes patients who are publicly insured;

The patient pays for a capped amount, e.g., for the first $20, of their out-of-pocket cost (co-pay or coinsurance) attributable to the specialty drug, e.g., ziconotide, in the prescription;

If the prescription includes one or more other medications, the patient costs will also include those costs attributable to the other medications, which may result in a higher out-of-pocket cost to the patient, e.g., greater than $20;

The maximum coverage may be capped, e.g., to $660 for each 1-mL vial, or $3300 for each 5-mL or 20-mL vial; and

The total savings to the patient over a particular period of time may be capped, e.g., the total savings may not exceed $8000 per calendar year.

In some embodiments, the maximum coverage can be capped to the wholesale acquisition cost (WAC) of the specialty drug. For example, the benefit to the patient can be capped to the maximum value of the actual vial, so that no party can profit from the benefit beyond the vial cost. The use of WAC can be used to account for any current or future price increases in place of an actual dollar amount, e.g., in place of the dollar amounts described herein.

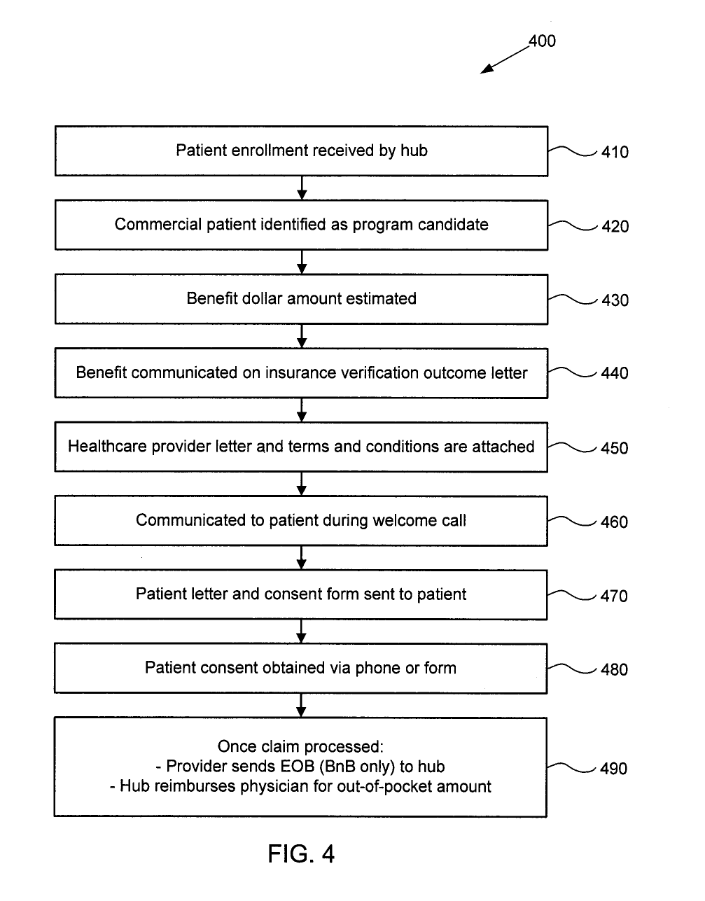

Additionally, or alternatively, in one exemplary implementation, the Savings Program can also be configured to implement process flow 400 illustrated in FIG. 4 and summarized below. Process flow 400 can include the patient enrollment being received by the hub (step 410). For example, as described further above, a physician can enroll the patient by submitting a suitable form to the hub. Process flow 400 further can include, if the patient is enrolled in a commercial insurance plan, identifying that patient as a candidate for the Savings Program (step 420). For example, the patient's enrollment can include information about any health insurance that the patient may have. If the patient has a commercial insurance plan, then the hub may categorically identify the patient as a candidate for the Savings Program; if the patient does not have a commercial insurance plan, e.g., if the patient is uninsured, or if the patient is publicly insured, then the hub may categorically identify the patient as not a candidate for the Savings Program. The hub may store patient enrollment information into data store 103 illustrated in FIG. 1.

Process flow 400 illustrated in FIG. 4 further can include estimating at the hub the dollar amount of the benefit for which the patient is eligible (step 430). An exemplary method of calculating such a dollar amount is illustrated in steps 330-350 of FIG. 3.

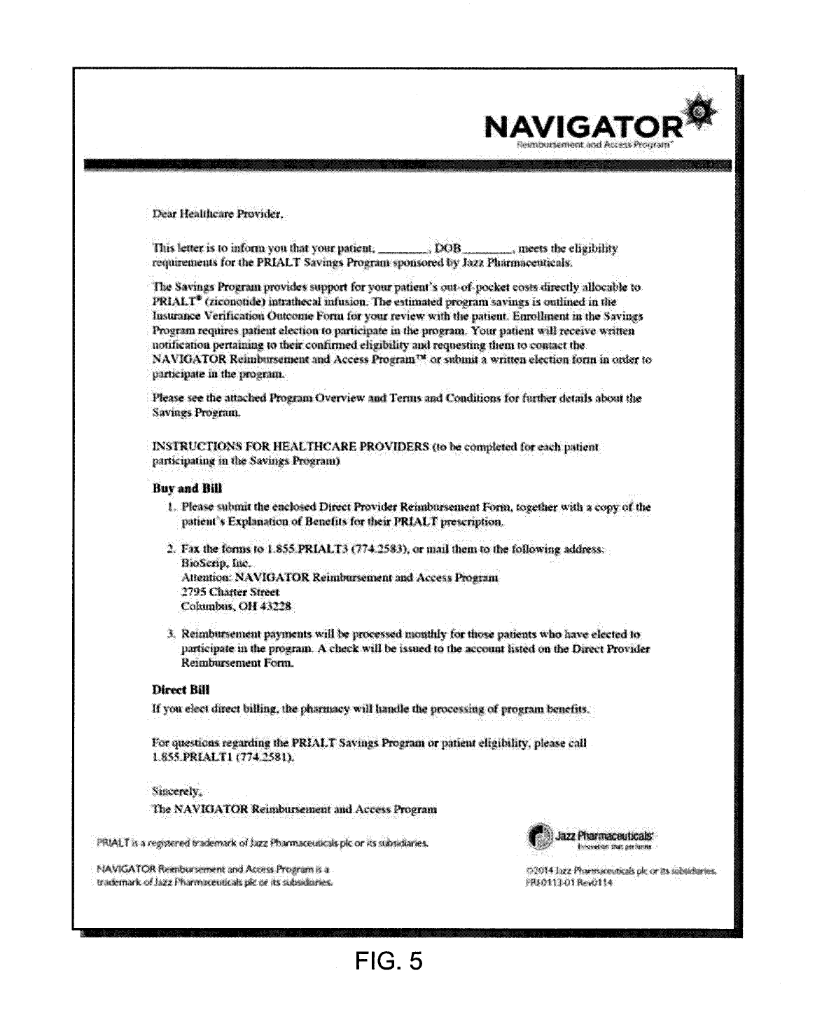

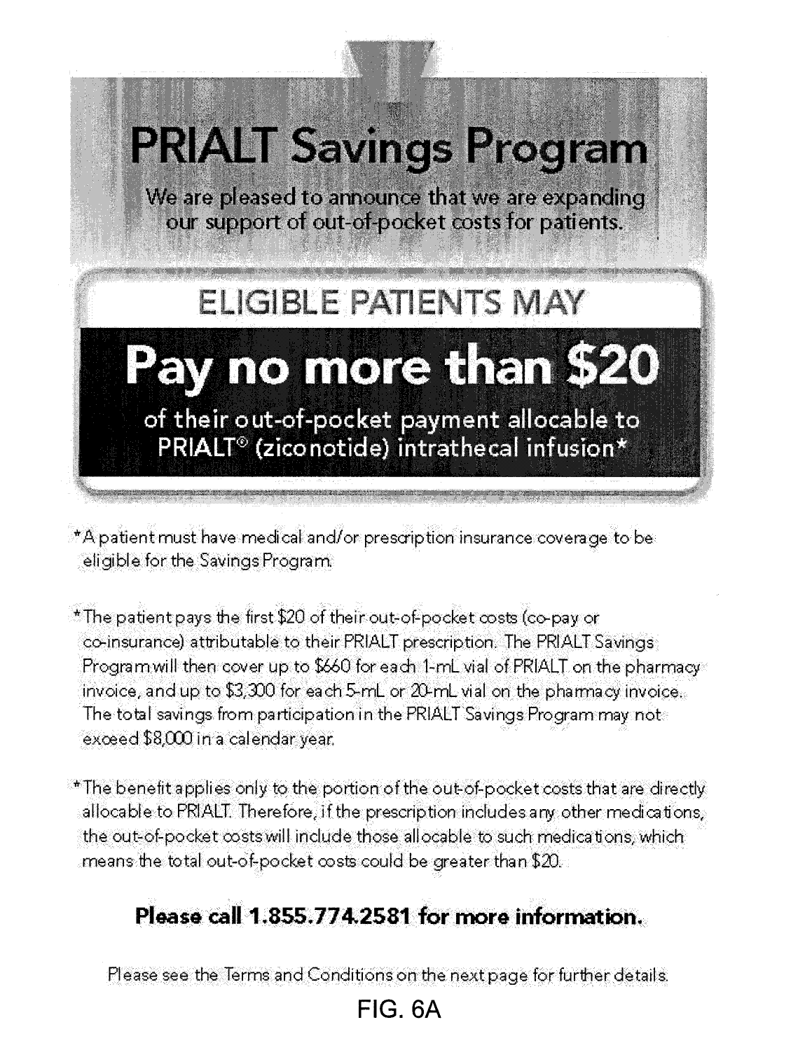

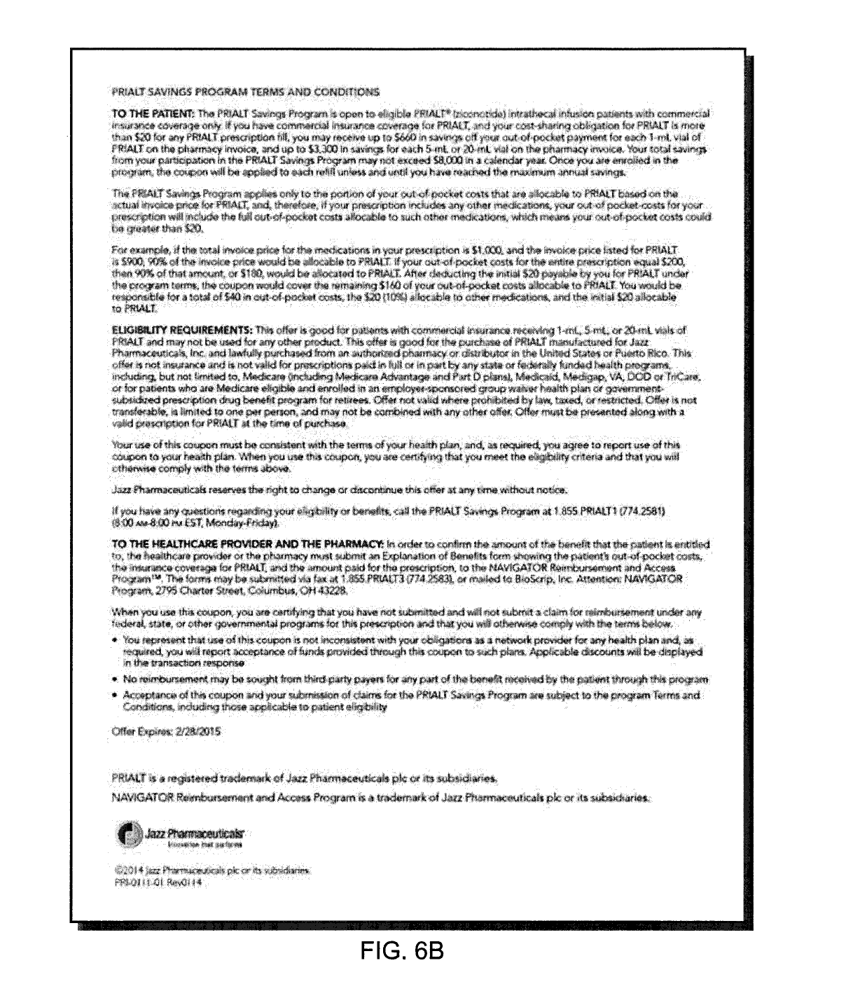

Referring again to FIG. 4, the benefit for which the patient is eligible may be communicated on insurance verification outcome (IVO) letter from the hub to the healthcare provider (step 440). An exemplary IVO letter is illustrated in FIG. 5. A healthcare provider letter describing the Savings Program and terms and conditions are attached (step 450). An exemplary provider letter regarding the Savings Program and terms and conditions are illustrated in FIGS. 6A-6B.

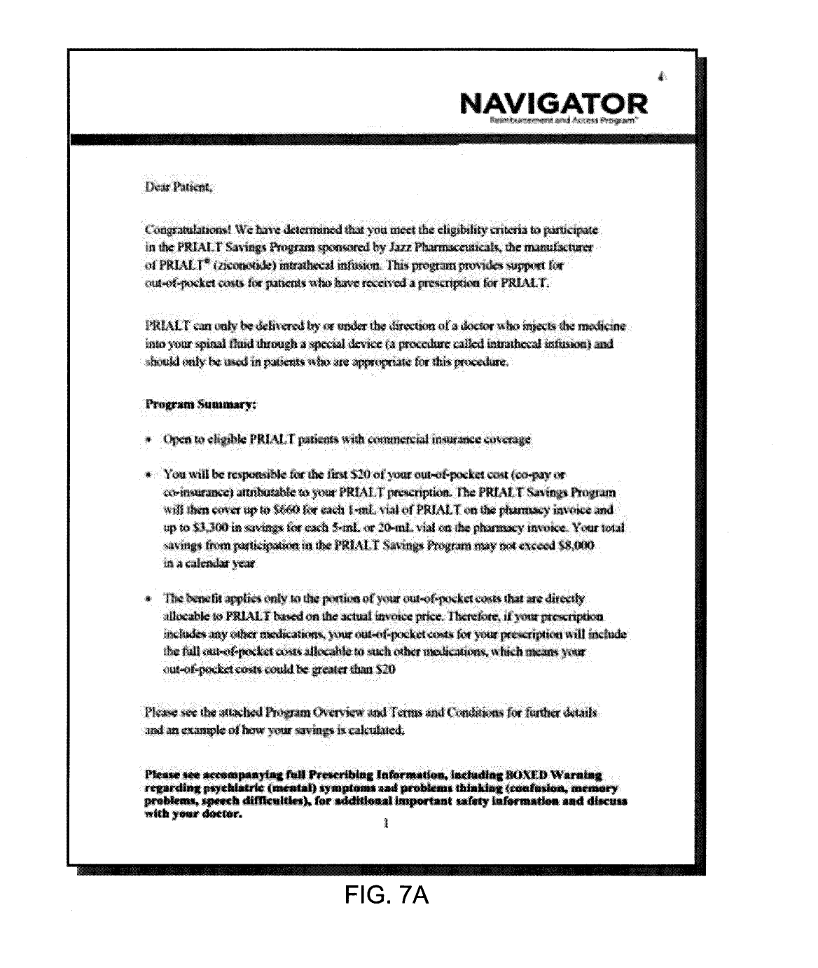

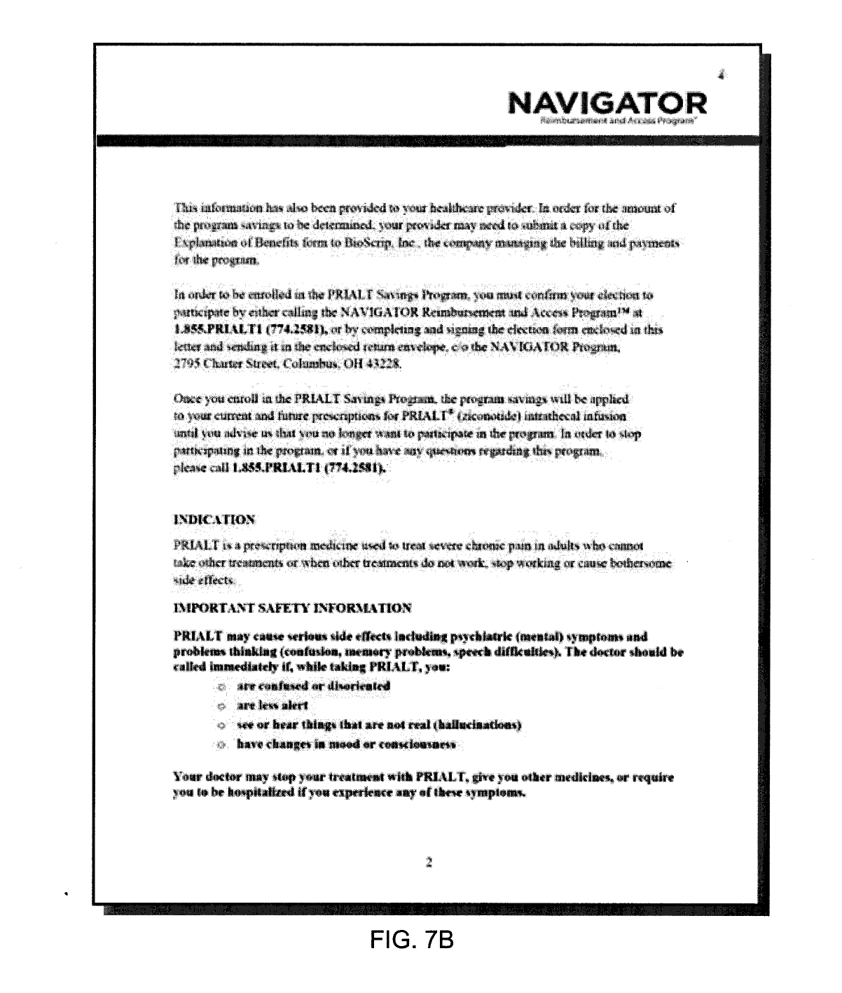

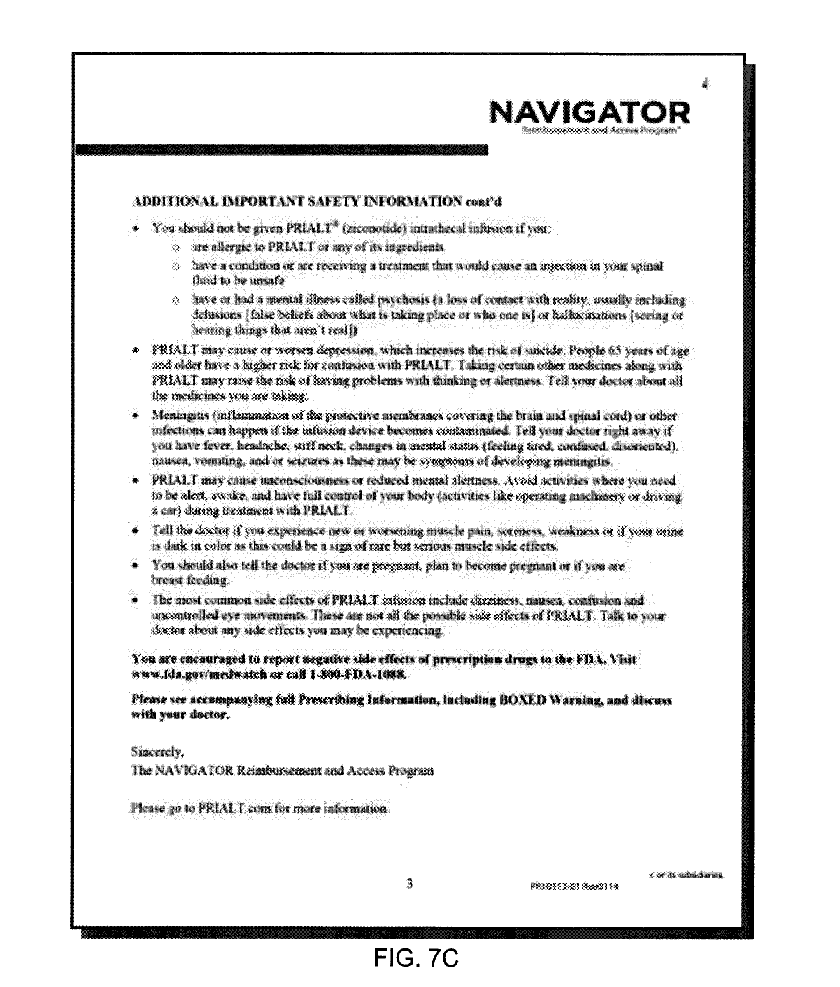

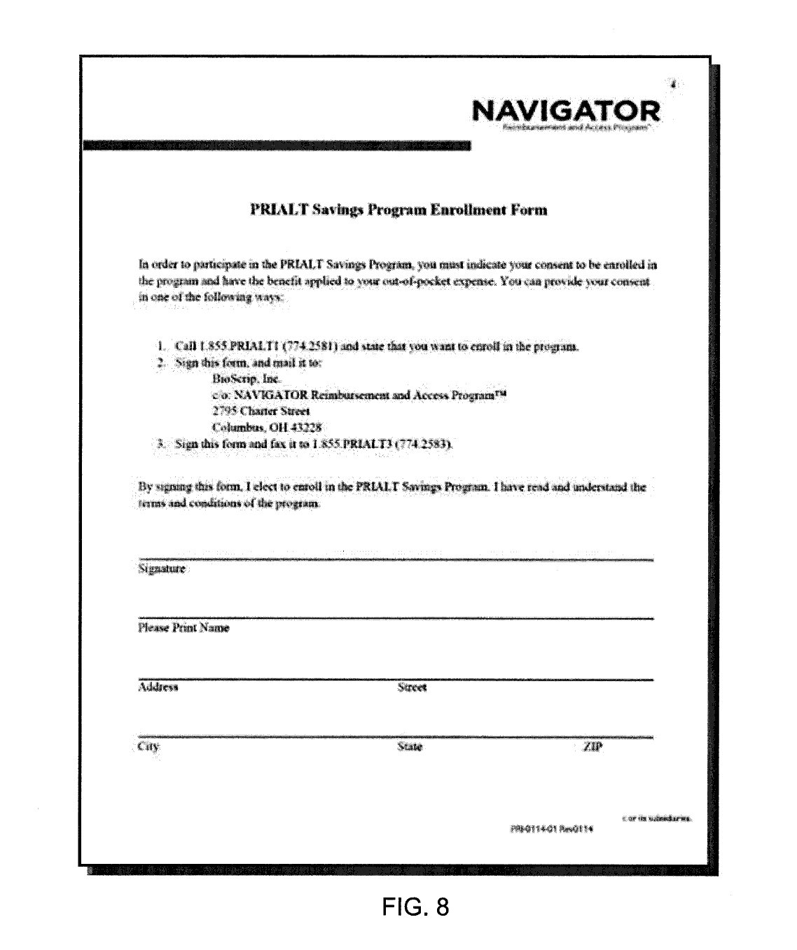

Process flow 400 further can include providing from the hub a welcome call to the patient, and informing the patient that he or she is a candidate for the Savings Program, e.g., based on step 330 of FIG. 3 (step 460). The hub may send a patient letter and consent form to the patient (step 470). An exemplary patient letter is illustrated in FIGS. 7A-7B. An exemplary consent form is illustrated in FIG. 8. Additionally, the hub may send a letter describing the Savings Program and terms and conditions to the patient. Such an exemplary letter and terms and conditions may be analogous to that illustrated in FIGS. 6A-6B. The hub may obtain patient consent via telephone or by return of the consent form (step 480). After the insurance claim is processed, the hub reimburses the physician for an out-of-pocket amount; additionally, if the physician selected Buy and Bill (BnB), the provider sends an explanation of benefits received from the insurance company to the hub (step 490). The hub can store written materials for explaining the Savings Program to any patients or physicians who may have questions.

In a first exemplary scenario, the physician prescribes the patient only the specialty drug, e.g., only ziconotide, the patient has commercial insurance with a patient out-of-pocket requirement of $100, and the capped payment amount is $20. The patient's initial obligation is $100, which is reduced to the capped payment amount of $20, yielding an $80 discount for the patient. The specialty drug manufacturer may absorb the $80 discount.

In a second exemplary scenario, the physician prescribes the patient multiple drugs, including the specialty drug, e.g., ziconotide, the patient has commercial insurance with a patient out-of-pocket requirement of $100, and the capped payment amount is $20. The total invoice amount of the specialty drug is $664, and the total invoice amount of the prescription is $700, so $664/$700=95% of the invoice is attributable to the specialty drug. The patient's initial obligation for only the specialty drug is $95, and is reduced to the capped amount of $20, yielding a $75 discount for the patient. The patient also is responsible for paying an additional $5 for the amount of the invoice attributable to the other drugs in the prescription, and thus pays a total of $25. The specialty drug manufacturer may absorb the $75 discount.

Note that the discount may be applied in different ways, depending on the physician's selected billing method. For example, if the physician selected Buy and Bill, the physician collects the patient's capped payment amount as well as any amount for which the patient is responsible based on other drugs in the prescription. The physician purchases the specialty drug, administers the specialty drug to the patient, and submits a claim to the patient's insurance company for reimbursement. The physician receives reimbursement for the specialty drug and an explanation of benefits (EOB) from the insurance company. The physician then submits the EOB to the hub. The hub reimburses the physician for the discount that the physician applied to the patient's payment responsibility. Alternatively, if the physician selected Direct Bill, the pharmacy collects the patient's capped payment amount as well as any amount for which the patient is responsible based on other drugs in the prescription. The pharmacy delivers the specialty drug to the physician, and submits a claim to the patient's insurance company for reimbursement. The pharmacy then submits the EOB to the hub. The hub reimburses the pharmacy for the discount that the pharmacy applied to the patient's payment responsibility. Note that under either of such alternatives, or any other potential implementation, the patient need not be issued any physical copayment card or physical coupon to be presented to the pharmacy, physician, or the manufacturer of the specialty pharmaceutical. Instead, the pharmacy is specifically educated about the specialty drug and about the Savings Program, and thus automatically may apply an appropriate discount to the patient's payment responsibility. Additionally, the physician may be educating about the Savings Program based on his or her enrollment to the hub, e.g., via an IVO form such as illustrated in FIG. 5 and the letter and terms and conditions such as illustrated in FIGS. 6A-6B. By so educating the pharmacy or the physician, or both the pharmacy and the physician, about the Savings Program, the patient's access to the specialty drug at reduced cost may be facilitated.

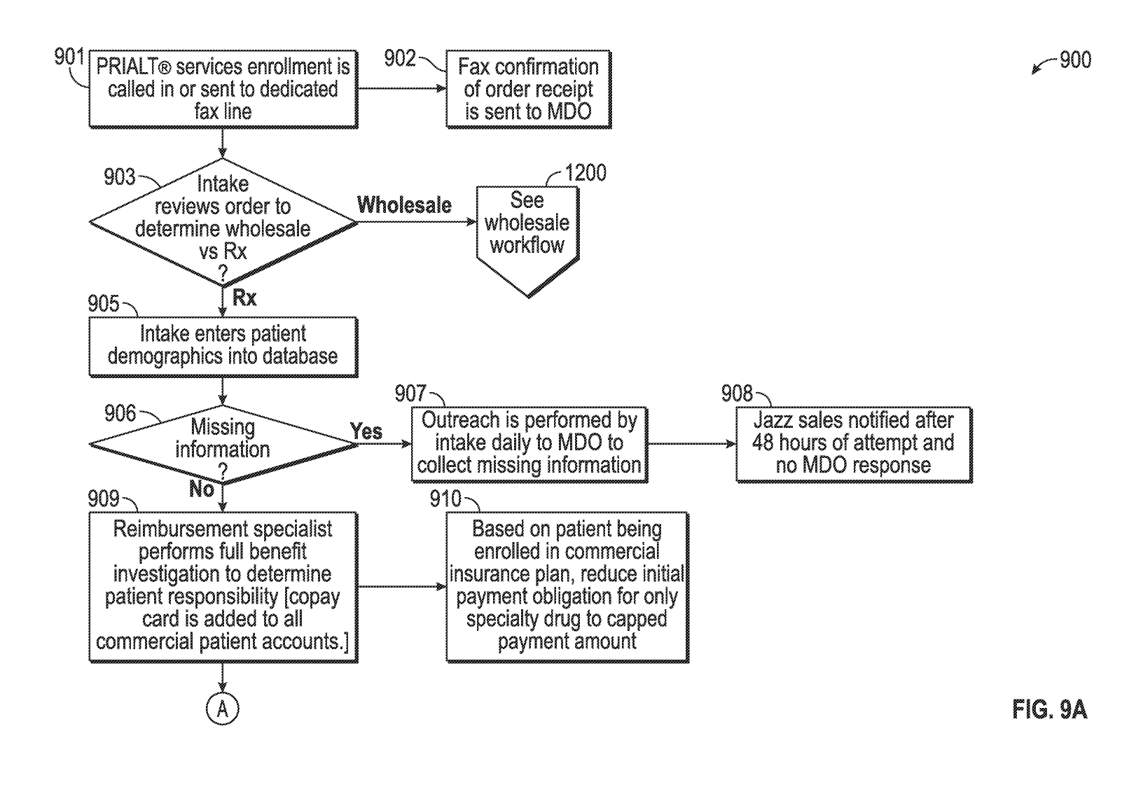

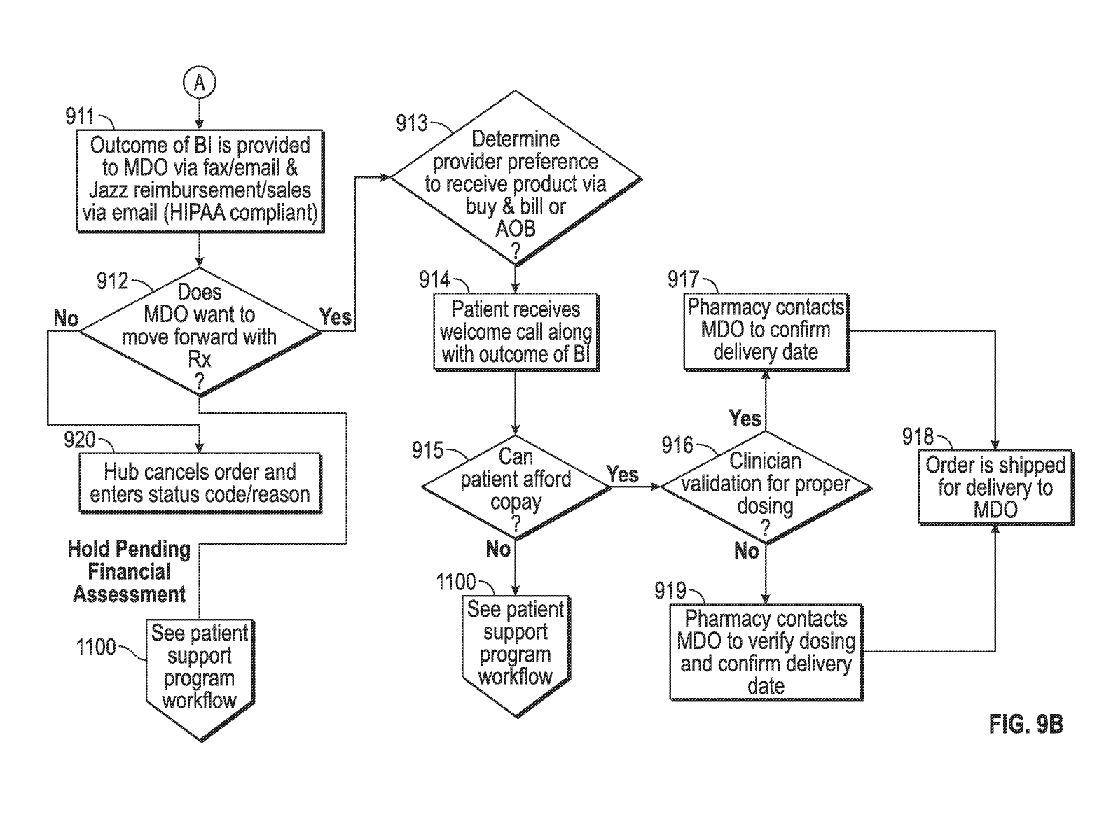

FIGS. 9-15 illustrate exemplary process flows that may be used to distribute a specialty drug with increased safety and reduced patient cost.

FIG. 9 illustrates an exemplary process flow 900 for distributing a specialty drug, e.g., ziconotide (trade name PRIALT®), for a new patient. At 901, a physician or patient enrollment, e.g., a PRIALT® Services enrollment, which includes an order for the specialty drug, is received by the hub via any suitable mode of communication, e.g., by telephone or by facsimile. A physician may enroll to the hub, or an enrolled physician may submit such an enrollment to the hub on behalf of the patient. In some embodiments, a physician enrollment includes identifying information about the physician and optionally a wholesale order for the specialty drug. In some embodiments, a patient enrollment includes identifying information about the patient and optionally an order for the specialty drug.

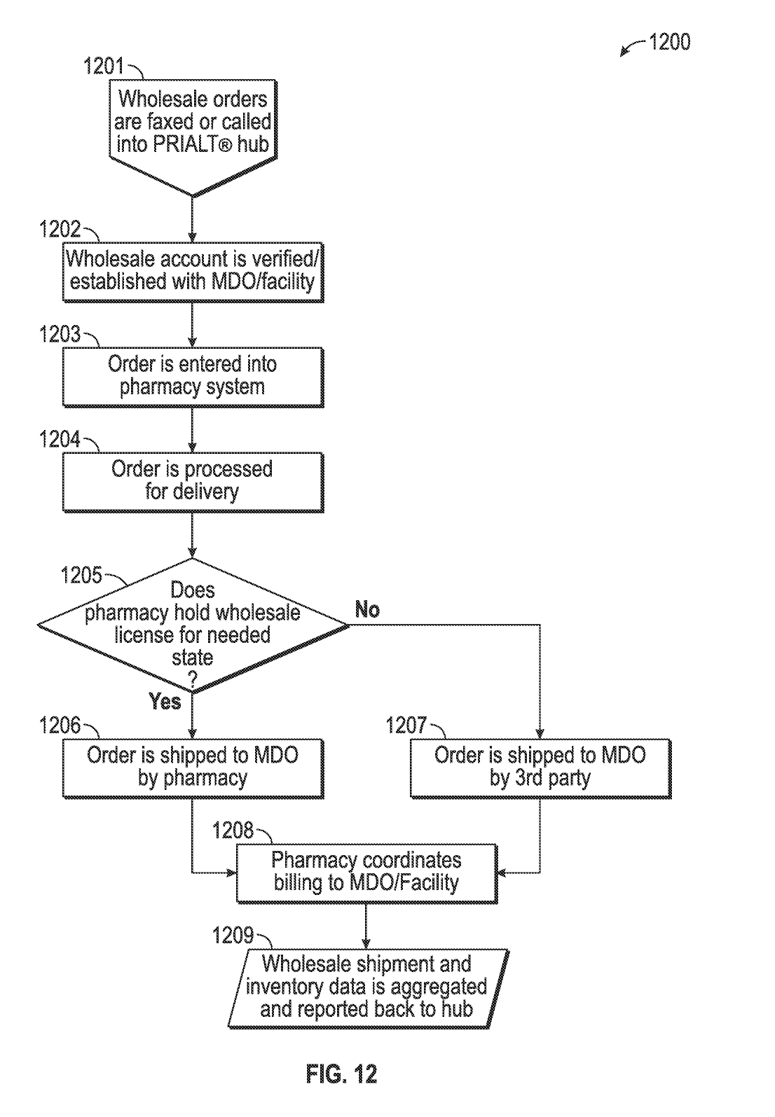

At 902, a confirmation of receipt of the enrollment and order is sent to the physician's office (which also may be referred to as a medical doctor office, or MDO). At 903, the hub reviews the order to determine whether it relates to a wholesale order or to a prescription (Rx). If the order relates to a wholesale order, e.g., the wholesale process flow 1200 illustrated in FIG. 12 can be used. If the order relates to a prescription, process flow 900 continues at 905, at which an intake portion of the hub enters patient information, e.g., patient demographics, into a database such as data store 103 illustrated in FIG. 1. It is then determined whether any patient information is missing. At 907, based on patient information being missing, the intake portion of the hub performs an outreach to the MDO, e.g., on a daily basis, to attempt to collect the missing information. At 908, the hub may notify the specialty drug manufacturer, e.g., a sales branch of Jazz Pharmaceuticals where the specialty drug is PRIALT®, based on there being no response from the MDO after a certain period of attempting to contact the MDO with no response, e.g., after 48 hours.

At 909, based on the patient information being complete, the hub, e.g., a reimbursement specialist at the hub, may perform a full benefit investigation to determine the patient responsibility, and a copayment card can be added to all commercial patient accounts. For example, at 910, based on the patient being enrolled in a commercial insurance plan, the patient's initial payment obligation for only the specialty drug can be reduced to a capped payment amount, e.g., using steps 330-350 described further above with reference to FIG. 3. The capped payment amount can be entered into a database such as data store 103 illustrated in FIG. 1. At 911, the outcome of the benefit investigation (BI) can be provided to the MDO via any suitable mode of communication, e.g., via email or facsimile, and also can be provided to the specialty drug manufacturer, e.g., to Jazz Pharmaceuticals where the specialty drug is PRIALT®, via any suitable mode of communication, e.g., via email. In the United States, any such communications can comply with the Heath Insurance Portability and Accountability Act (HIPAA). For example, the hub may associate the patient with a unique number, and may provide that number to the specialty drug manufacturer rather than providing the patient's name or other identifying information to the manufacturer. In other countries, any such communications can comply with local laws and regulations.

At 912, the hub determines whether the MDO wants to move forward with the prescription, e.g., by receiving an indication of the MDO's decision via any suitable mode of communication. The received indication can be entered into a database such as data store 103 illustrated in FIG. 1. Based upon receiving an indication that the MDO wants to move forward with the prescription, at 913 the physician (provider)'s billing selected is determined, e.g., the hub receives a communication from the MDO whether the physician selected to receive the product via Buy and Bill or via Direct Bill (AOB). The physician's billing selection can be entered into a database such as data store 103 illustrated in FIG. 1.

At 914, the hub suitably communicates with the patient, e.g., telephones the patient or sends one or more letters, or both telephones the patient and sends one or more letters, to provide a welcome call and to inform the patient of the outcome of the benefits investigation (BI). For example, if the hub determines that the patient is eligible for the Savings Program, the hub may inform the patient of such eligibility. At 915, the hub receives an indication from the patient as to whether the patient can afford any copayment obligation that the patient may have for the specialty drug. For example, based upon the patient being enrolled in a commercial insurance plan, the hub may receive an indication from the patient as to whether the patient can afford the capped payment amount that can be calculated at step 910 of process flow 900 and steps 330-350 of process flow 300 illustrated in FIG. 3. Or, for example, based upon the patient not being enrolled in a commercial insurance plan, e.g., being enrolled in a public insurance plan or being uninsured, the hub may receive an indication from the patient as to whether the patient can afford any copayment obligations that the patient may have, e.g., an obligation for the full price of the specialty drug based on the patient being uninsured. The patient's indication of his or her ability to afford any copayment obligation can be entered into a database such as data store 103 illustrated in FIG. 1.

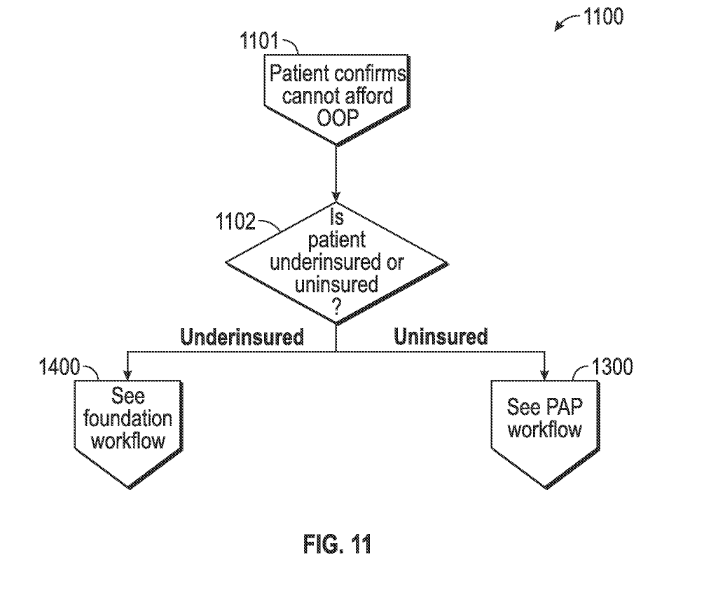

At 916, responsive to receiving an indication from the patient that the patient can afford any copayment obligation, the hub transmits the prescription to the pharmacy via any suitable mode of communication, and a clinician at the pharmacy validates the prescription, e.g., determines whether the dose of the specialty drug appears to be proper for the patient. As noted above, in certain embodiments, the pharmacy may operate the hub, in which case the hub need not necessarily take any additional step to transmit the prescription to the pharmacy. At 917, based upon the clinician validating the prescription, the pharmacy can contact the MDO via any suitable mode of communication to confirm the anticipated date on which the specialty drug is to be delivered to the physician. At 918, the pharmacy then ships the order for delivery to the MDO. At 919, based upon the clinician determining that the dose of the specialty drug does not appear to be proper for the patient, the pharmacy can contact the MDO via any suitable mode of communication to verify the proper dosing of the specialty drug and to confirm the anticipated date on which the specialty drug is to be delivered to the physician. At 918, the pharmacy then ships the order for delivery to the MDO. The clinician's indication of whether the prescription is validated can be entered into a database such as data store 103 illustrated in FIG. 1. Based upon receiving an indication from the patient that the patient cannot afford any copayment obligation, patient support program process flow 1100 illustrated in FIG. 11 can be used.

Referring again to 912, based upon receiving an indication that the MDO does not want to move forward with the prescription, at 920 the hub cancels the order and enters an indication of the reason for not moving forward, e.g., via a status code or a text-based entry. Such an indication can be entered into a database such as data store 103 illustrated in FIG. 1. Alternatively, based upon receiving an indication that the MDO wants to hold the prescription pending a financial assessment of the patient, e.g., whether the patient may qualify for alternative funding, patient support program process flow 1100 illustrated in FIG. 11 can be used.

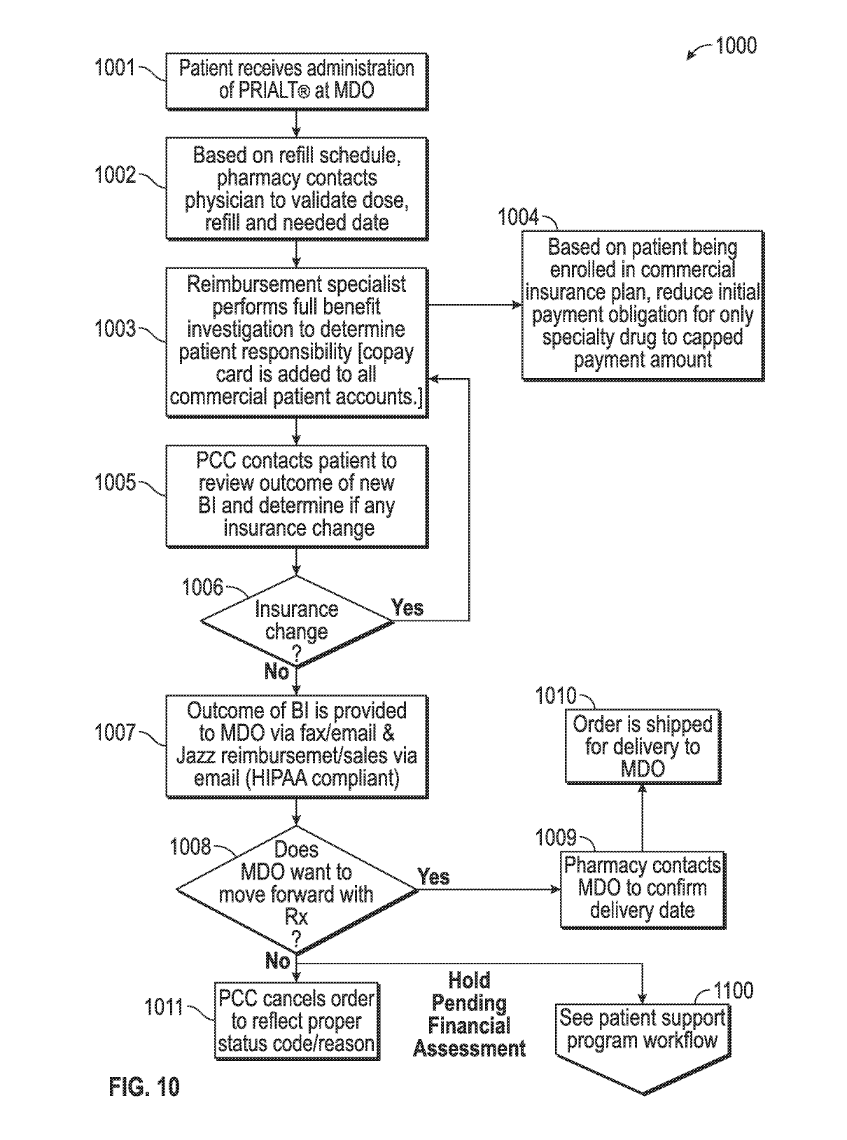

As noted further above, the hub can determine the patient's financial status responsive to each prescription, whether it be a refill or a new prescription. For example, the patient's insurance plan or out-of-pocket responsibility may change, or the cost or amount of the specialty drug or one or more other drugs to be co-administered with the specialty drug may change. FIG. 10 is a flowchart of an exemplary process 1000 for refilling a prescription for a specialty drug using a computer hub operating at a single access point. At 1001, based on a previous prescription, the physician administers the specialty drug, e.g., PRIALT®, to the patient at the MDO. The previous prescription may include one or more refills. At 1002, based on the refill schedule, the pharmacy can contact the physician to obtain an indication of whether a refill is desired, to validate the dose for such refill, and the desired date for such refill. The clinician's indications of whether the refill is desired, the dose for such refill, and the desired date for such refill can be entered into a database such as data store 103 illustrated in FIG. 1.

Responsive to the received indications regarding the refill, at 1003 the hub, e.g., a reimbursement specialist at the hub, may perform a full benefit investigation to determine the patient responsibility, and a copayment card can be added to all commercial patient accounts. For example, at 1004, based on the patient being enrolled in a commercial insurance plan, the patient's initial payment obligation for only the specialty drug can be reduced to a capped payment amount, e.g., using steps 330-350 described further above with reference to FIG. 3. As described above, based upon whether there is any change in the cost or amount of the specialty drug or any other drug in the prescription, the reduction to the patient's initial payment obligation for only the specialty drug, and the patient's final payment responsibility for the prescription, may change. The capped payment amount determined at 1004 can be entered into a database such as data store 103 illustrated in FIG. 1.

At 1005, the hub suitably communicates with the patient, e.g., telephones the patient or sends one or more letters, or both telephones the patient and sends one or more letters, to inform the patient of the outcome of the benefits investigation (BI). For example, if the hub determines that the patient is eligible for the Savings Program in association with the refill, the hub may inform the patient of such eligibility. The hub also may obtain an indication from the patient about any change in the patient's insurance plan or out-of-pocket responsibility. The patient's indication of any change in the patient's insurance plan or out-of pocket responsibility can be entered into a database such as data store 103 illustrated in FIG. 1.

At 1006, the hub determines based upon such indication whether there was any change in the insurance. If so, at 1003 the hub re-performs the a full benefit investigation and at 1004, based on the patient being enrolled in a commercial insurance plan, the patient's initial payment obligation for only the specialty drug can be reduced to a capped payment amount, e.g., using steps 330-350 described further above with reference to FIG. 3. At 1005, the hub again suitably communicates with the patient, e.g., telephones the patient or sends one or more letters, or both telephones the patient and sends one or more letters, to inform the patient of the outcome of the re-performance of the benefits investigation (BI), and at 1006 obtains an indication from the patient about any change in the patient's insurance plan or out-of-pocket responsibility. Based upon there being one or more further changes, steps 1003-1006 may be performed any suitable number of times.

At 1007, the outcome of the one or more benefit investigations (BI) can be provided to the MDO via any suitable mode of communication, e.g., via email or facsimile, and also can be provided to the specialty drug manufacturer, e.g., to Jazz Pharmaceuticals where the specialty drug is PRIALT®, via any suitable mode of communication, e.g., via email. In the United States, any such communications can comply with the Heath Insurance Portability and Accountability Act (HIPAA). For example, the hub may associate the patient with a unique number, and may provide that number to the specialty drug manufacturer rather than providing the patient's name or other identifying information to the manufacture. In other countries, any such communications preferably comply with local laws and regulations.

At 1008, the hub determines whether the MDO wants to move forward with the prescription, e.g., by receiving an indication of the MDO's decision via any suitable mode of communication. The received indication can be entered into a database such as data store 103 illustrated in FIG. 1. Based upon receiving an indication that the MDO wants to move forward with the prescription, at 1009 the hub transmits the prescription to the pharmacy via any suitable mode of communication. As noted above, in certain embodiments, the pharmacy may operate the hub, in which case the hub need not take any additional step to transmit the prescription to the pharmacy. Additionally, because the dose has already been validated at 1002, no further step of validating the dose need necessarily be taken. At 1009, the pharmacy can contact the MDO via any suitable mode of communication to confirm the anticipated date on which the specialty drug is to be delivered to the physician. At 1010, the pharmacy then ships the order for delivery to the MDO.

Referring again to 1008, based upon receiving an indication that the MDO does not want to move forward with the prescription, at 1011 the hub cancels the order and enters an indication of the reason for not moving forward, e.g., via a status code or a text-based entry. Such an indication can be entered into a database such as data store 103 illustrated in FIG. 1. Alternatively, based upon receiving an indication that the MDO wants to hold the prescription pending a financial assessment of the patient, e.g., whether the patient may qualify for alternative funding, patient support program process flow 1100 illustrated in FIG. 11 can be used.

FIG. 11 is a flowchart of an exemplary process for reducing patient costs for a specialty drug using a computer hub operating at a single access point. At 1101, the hub receives a confirmation from the patient that the patient cannot afford any copayment obligation that the patient may have for the specialty drug. For example, based upon the patient being enrolled in a commercial insurance plan, the hub may receive an indication from the patient that the patient cannot afford the capped payment amount that can be calculated at step 910 of process flow 900 and steps 330-350 of process flow 300 illustrated in FIG. 3. Or, for example, based upon the patient not being enrolled in a commercial insurance plan, e.g., being enrolled in a public insurance plan or being uninsured, the hub may receive an indication from the patient that the patient cannot afford any copayment obligations that the patient may have, e.g., an obligation for the full price of the specialty drug based on the patient being uninsured. The patient's indication of his or her inability to afford any copayment obligation can be entered into a database such as data store 103 illustrated in FIG. 1.

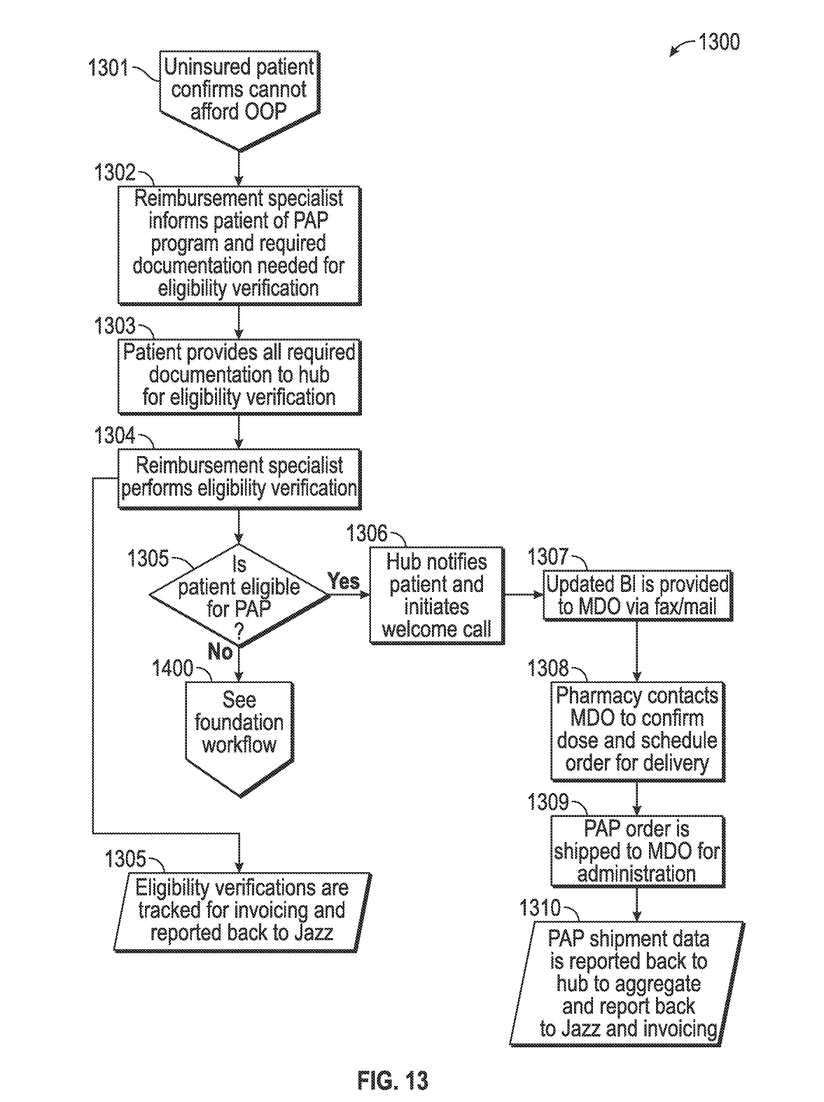

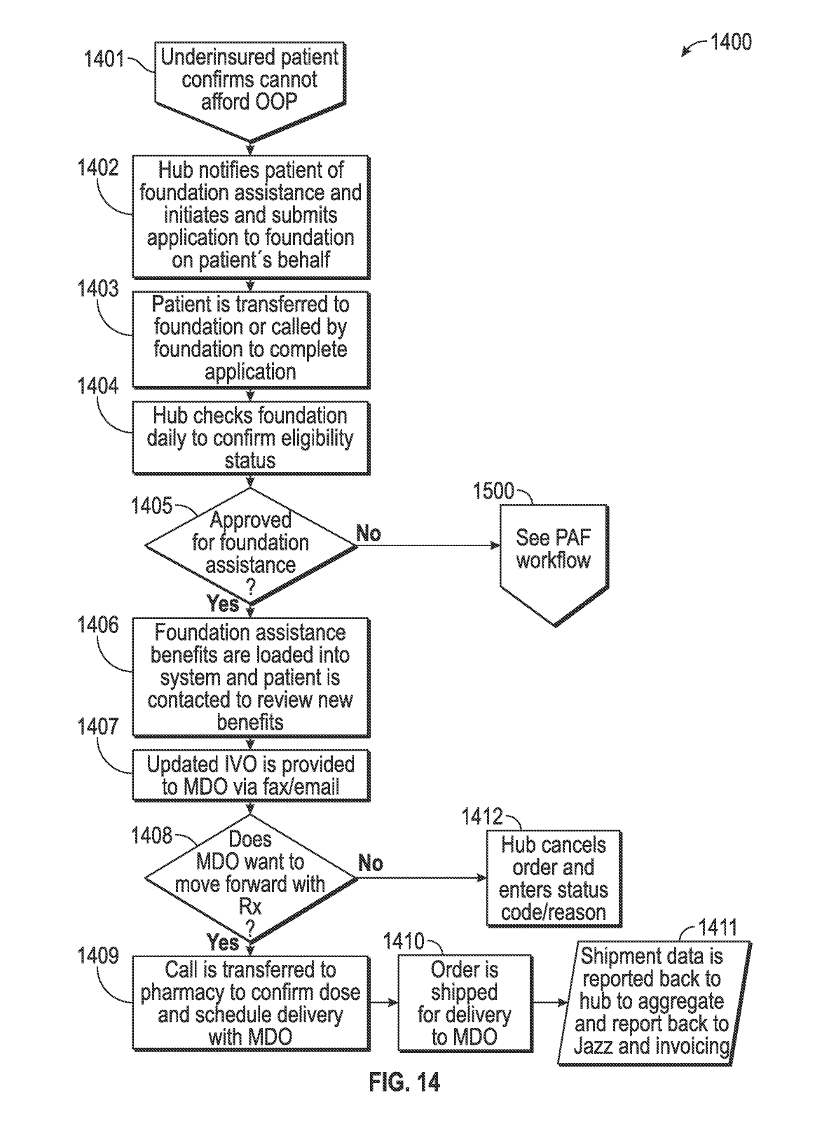

At 1102, the hub receives an indication from the patient as to whether the patient is underinsured or uninsured. The patient's indication of his or her being underinsured or uninsured can be entered into a database such as data store 103 illustrated in FIG. 1. Based upon the patient being underinsured, process flow 1400 illustrated in FIG. 14 can be used. Based upon the patient being uninsured, process flow 1300 illustrated in FIG. 13 can be used.

FIG. 12 is a flowchart of an exemplary process flow for wholesale distribution of a specialty drug using a computer hub operating at a single access point. At 1201, wholesale orders for the specialty drug are provided to the hub, e.g., to the PRIALT® hub where the specialty drug is PRIALT®, via any suitable mode of communication, e.g., by telephone or facsimile. The wholesale orders can be entered into a database such as data store 103 illustrated in FIG. 1.

At 1202, enrollment, e.g., establishment of a wholesale account, of the MDO or facility is verified, e.g., by entering a suitable query into a database storing enrollment information such as data store 103 illustrated in FIG. 1. Note that wholesale accounts may be established not only with a physician (MDO), but also with facilities such as hospitals which may wish to order the specialty drug on a wholesale basis on behalf of multiple physicians affiliated with the facility. Such a facility may be enrolled to the hub using an analogous procedure to that of enrolling physicians such as described elsewhere herein.

At 1203, responsive to receiving the order, the hub transmits the prescription to the pharmacy via any suitable mode of communication. As noted above, in certain embodiments, the pharmacy may operate the hub, in which case the hub need not take any additional step to transmit the prescription to the pharmacy or to enter the order. At 1204, the hub then processes the order for delivery. At 1205, the hub or the pharmacy then determines whether the pharmacy holds a wholesale license in the needed state, e.g., in the state of the MDO or facility to which the order is to be shipped. An indication of which states the pharmacy holds a wholesale license can be stored in a database such as data store 103 illustrated in FIG. 1. At 1206, based upon the pharmacy holding a wholesale license in the needed state, the pharmacy then ships the order for delivery to the MDO or facility, e.g., prepares and delivers or coordinates delivery of the specialty drug to the MDO or facility, e.g., using the specialized handling procedures and specialized prescription filling procedures as appropriate for the wholesale order. Alternatively, at 1207, based upon the pharmacy not holding a wholesale license in the needed state, the order suitably may be communicated to a third party that may ship the order to the MDO or facility, e.g., using the specialized handling procedures and specialized prescription filling procedures as appropriate for the wholesale order. At 1208, the pharmacy coordinates billing of the wholesale order to the MDO or facility appropriately based on the party who shipped the order to the MDO or facility, and the billing selection of the MDO or facility, e.g., Buy and Bill or Direct Bill. At 1209, the pharmacy aggregates wholesale shipment and inventory data and reports such data to the hub. As noted above, in certain embodiments, the pharmacy may operate the hub, in which case the hub need not take any additional step to report such data to the hub. The data can be stored in a database such as data store 103 illustrated in FIG. 1.

FIG. 13 is a flowchart of an exemplary process 1300 for enrolling a new patient and reducing that patient's costs for a specialty drug using a computer hub operating at a single access point. At 1301, the hub receives a confirmation from the patient that the patient cannot afford any out-of-pocket (OOP) obligation that the patient may have for the specialty drug. For example, based upon the patient being uninsured, the hub may receive an indication from the patient that the patient cannot afford any out-of-pocket obligations that the patient may have, e.g., an obligation for the full price of the specialty drug. The patient's indication of his or her inability to afford any out-of-pocket obligation can be entered into a database such as data store 103 illustrated in FIG. 1.

At 1302, the hub, e.g., a reimbursement specialist at the hub, can inform the patient of a Patient Assistance Program (PAP) that may reduce or eliminate the patient's out-of-pocket obligation, and inform the patient of any required documentation that may be needed to verify the patient's eligibility for the program, to the extent that such documentation was not provided during patient enrollment to the hub. The documentation may include, for example, one or more of: evidence of the patient's own income or the patient's household income, e.g., the most recent federal tax return; evidence that the patient is a U.S. citizen or legal resident for patients applying to PAP in the United States, or evidence that the patient is a citizen or legal resident of another jurisdiction for patients applying to the PAP in that jurisdiction, e.g., a copy of the patient's birth certificate; or evidence that the patient does not have commercial insurance, e.g., a declaration or signed statement by the patient that the patient does not have commercial insurance. At 1303, the hub can receive from the patient all required documentation for verification of eligibility for PAP. The required documentation can be entered into a database such as data store 103 illustrated in FIG. 1.

At 1304 the hub, e.g., a reimbursement specialist at the hub, verifies the patient's eligibility for PAP. For example, for patients applying to PAP in the United States, the hub can confirm whether or not the patient is uninsured, has a sufficiently low income, e.g., an income less than 100% of the federal poverty level, or less than 200% of the federal poverty level, and is a U.S. citizen or legal resident. At 1305, the hub tracks eligibility verifications for invoicing and reports the verifications and invoices back to the specialty drug manufacturer, e.g., to Jazz Pharmaceuticals where the specialty drug is PRIALT®. Verifications of eligibility and invoices can be entered into a database such as data store 103 illustrated in FIG. 1.

At 1305 the hub, based on the verification of the patient's eligibility for PAP, determines whether the patient is eligible for PAP, e.g., if the patient meets all criteria for PAP. At 1306, based upon determining that the patient is eligible for PAP, the hub can notify the patient of his or her eligibility via any suitable mode of communication, e.g., via a welcome telephone call. At 1307, the hub informs the physician (MDO) of the updated benefits investigation (BI) for the patient via any suitable mode of communication, e.g., via facsimile or email. At 1308, the pharmacy contacts the MDO via any suitable mode of communication to confirm the dose of the specialty drug and to schedule the order for delivery to the MDO. At 1309 the pharmacy ships the order, which may be referred to as a “PAP order,” to the MDO for administration to the patient. At 1310, the hub can track shipment data for PAP orders and aggregates and reports shipments back to the specialty drug manufacturer, e.g., to Jazz Pharmaceuticals where the specialty drug is PRIALT®, for invoicing. For example, the specialty drug manufacturer may absorb all or a portion of the cost for the specialty drug for patients eligible for PAP. As such, the MDO may collect no payment, or a reduced payment, from the patient in association with administration of the specialty drug. Alternatively, at 1311, based upon determining that the patient is not eligible for PAP, process flow 1400 illustrated in FIG. 14 can be used to attempt to reduce patient costs for underinsured patients.

FIG. 14 is a flowchart of an exemplary process 1400 for reducing patient costs for a specialty drug using a computer hub operating at a single access point. At 1401, the hub receives a confirmation from the patient that the patient cannot afford any out-of-pocket (OOP) obligation that the patient may have for the specialty drug. For example, based upon the patient being underinsured by a commercial insurance company or by public insurance, the hub may receive an indication from the patient that the patient cannot afford any out-of-pocket requirements that the patient's insurer may impose upon the patient. The patient's indication of his or her inability to afford any out-of-pocket obligation can be entered into a database such as data store 103 illustrated in FIG. 1.

At 1402 the hub, e.g., a reimbursement specialist at the hub, or the pharmacy, can inform the patient about foundation assistance that may reduce or eliminate the patient's out-of-pocket obligation via any suitable mode of communication, e.g., by telephone or letter, and initiates and submits an application to the foundation on the patient's behalf. For example, the foundation may have an online application that the hub may complete on behalf of the patient, e.g., may populate with patient enrollment information stored in a database such as data store 103 illustrated in FIG. 1, and may submit on behalf of the patient. At 1403, the hub may transfer the patient to the foundation, e.g., may connect the patient with the foundation by telephone for completion of the application and further information about the foundation, or the foundation may call the patient for completion of the application and to provide further information about the foundation.

At 1404 the hub can periodically, e.g., daily, check with the foundation to confirm the patient's status of eligibility for financial support by the foundation. For example, the foundation may have an online site that the hub can access to confirm the patient's status of eligibility. Alternatively, the foundation may contact the hub to inform the hub of the patient's status of eligibility. At 1405, the hub receives from the foundation an indication of whether the foundation has approved the patient for foundation assistance. The indication of foundation assistance for a patient can be entered into a database such as data store 103 illustrated in FIG. 1. At 1406, information about the benefits of foundation assistance are loaded into the system, e.g., entered into a database such as data store 103 illustrated in FIG. 1, and the hub contacts the patient via any suitable mode of communication, e.g., by telephone, to review the new benefits. Such benefits can include the foundation agreeing to pay for all or a part of the patient's out-of-pocket obligation for the specialty drug.

At 1407, the hub provides an updated IVO to the physician (MDO) for the patient via any suitable mode of communication, e.g., via facsimile or email, so as to inform the physician of the patient's approval to receive foundation assistance. At 1408, the hub determines whether the MDO wants to move forward with the prescription, e.g., by receiving an indication of the MDO's decision via any suitable mode of communication. The received indication can be entered into a database such as data store 103 illustrated in FIG. 1. Based upon receiving an indication that the MDO wants to move forward with the prescription, at 1409 the pharmacy contacts the MDO via any suitable mode of communication to confirm the dose of the specialty drug and to schedule the order for delivery to the MDO. At 1410 the pharmacy ships the order to the MDO for administration to the patient. At 1411 the hub can track shipment data for the order and aggregates and reports shipments back to the specialty drug manufacturer, e.g., to Jazz Pharmaceuticals where the specialty drug is PRIALT®, for invoicing. For example, the specialty drug manufacturer may invoice the foundation for all or a portion of the specialty drug.

Referring again to 1408, based upon receiving an indication that the MDO does not want to move forward with the prescription, at 1412 the hub notifies the patient via any suitable mode of communication, cancels the order, and enters an indication of the reason for not moving forward, e.g., via a status code or a text-based entry. Such an indication can be entered into a database such as data store 103 illustrated in FIG. 1.

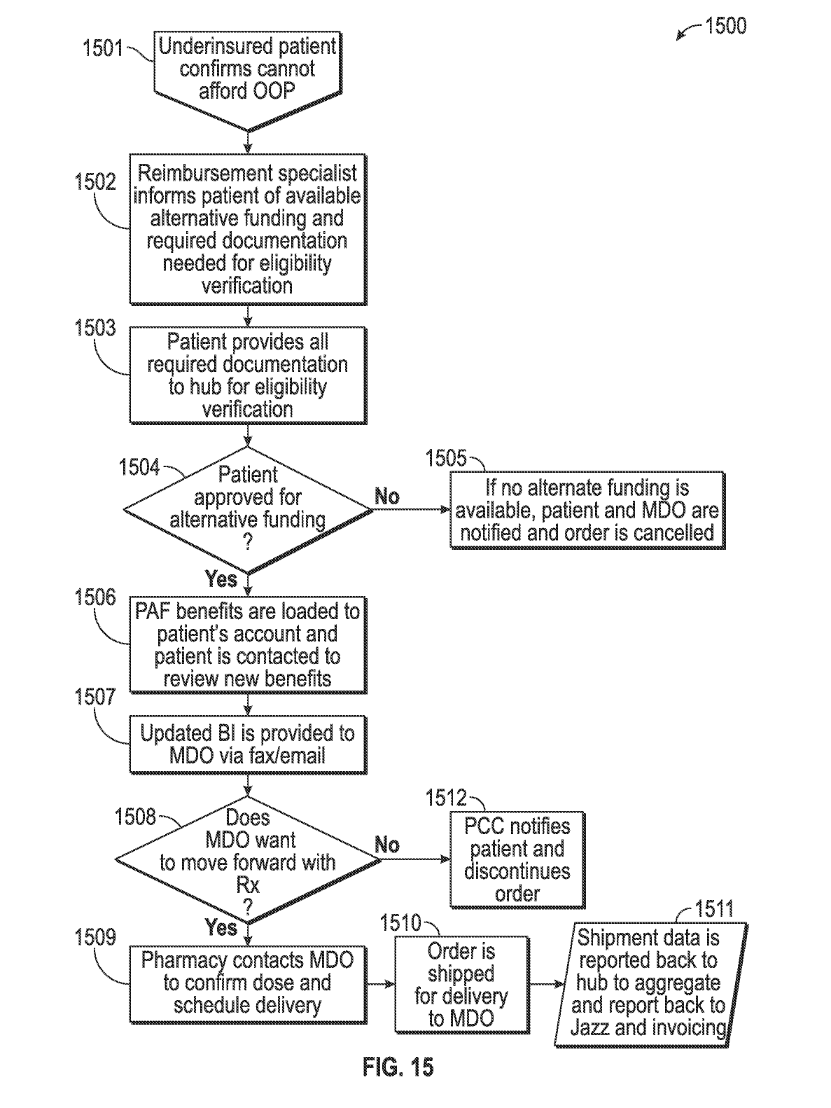

FIG. 15 is a flowchart of an exemplary process for reducing patient costs for a specialty drug using a computer hub operating at a single access point.

At 1501, the hub receives a confirmation from the patient that the patient cannot afford any out-of-pocket (OOP) obligation that the patient may have for the specialty drug. For example, based upon the patient being underinsured by a commercial insurance company or by public insurance, the hub may receive an indication from the patient that the patient cannot afford any out-of-pocket requirements that the patient's insurer may impose upon the patient. The patient's indication of his or her inability to afford any out-of-pocket obligation can be entered into a database such as data store 103 illustrated in FIG. 1.

At 1502, the hub, e.g., a reimbursement specialist at the hub, can inform the patient of available alternative funding that may reduce or eliminate the patient's out-of-pocket obligation, and inform the patient of any required documentation that may be needed to verify the patient's eligibility for the program, to the extent that such documentation was not provided during patient enrollment to the hub. The documentation may include, for example, one or more of: evidence of the patient's own income or the patient's household income, e.g., the most recent federal tax return; evidence that the patient is a U.S. citizen or legal resident for patients applying for alternative funding in the United States, or evidence that the patient is a citizen or legal resident of another jurisdiction for patients applying for alternative funding in that jurisdiction, e.g., a copy of the patient's birth certificate; or evidence that the patient is underinsured, e.g., a declaration or signed statement by the patient that the patient has commercial insurance or public insurance, but cannot afford an out-of-pocket requirement by that insurance. At 1503, the hub preferably receives from the patient all required documentation for verification of eligibility for alternative funding. The required documentation can be entered into a database such as data store 103 illustrated in FIG. 1.

At 1504 the hub, e.g., a reimbursement specialist at the hub, verifies the patient's eligibility for alternative funding. For example, for patients applying for alternative funding in the United States, the hub can confirm whether or not the patient is underinsured, has a sufficiently low income, e.g., an income less than 100% of the federal poverty level, or less than 200% of the federal poverty level, and is a U.S. citizen or legal resident, e.g., determines whether the patient meets all criteria for alternative funding. At 1506, based upon determining that the patient is eligible for alternative funding, the hub can load the benefits of the alternative funding into the patient's account, e.g., enters the benefits into a database such as data store 103 illustrated in FIG. 1, and notifies the patient of the benefits via any suitable mode of communication, e.g., via a telephone call or letter. At 1507, the hub informs the physician (MDO) of the updated benefits investigation (BI) for the patient via any suitable mode of communication, e.g., via facsimile or email.

At 1508, the hub determines whether the MDO wants to move forward with the prescription, e.g., by receiving an indication of the MDO's decision via any suitable mode of communication. The received indication can be entered into a database such as data store 103 illustrated in FIG. 1. Based upon receiving an indication that the MDO wants to move forward with the prescription, at 1509 the pharmacy contacts the MDO via any suitable mode of communication to confirm the dose of the specialty drug and to schedule the order for delivery to the MDO. At 1510 the pharmacy ships the order to the MDO for administration to the patient. At 1511 the hub can track shipment data for the order and aggregates and reports shipments back to the specialty drug manufacturer, e.g., to Jazz Pharmaceuticals where the specialty drug is PRIALT®, for invoicing. For example, the specialty drug manufacturer may absorb all or a portion of the cost for the specialty drug for patients eligible for PAP. As such, the MDO may collect no payment, or a reduced payment, from the patient in association with administration of the specialty drug.

Referring again to 1508, based upon receiving an indication that the MDO does not want to move forward with the prescription, at 1512 the hub notifies the patient via any suitable mode of communication, cancels the order, and enters an indication of the reason for not moving forward, e.g., via a status code or a text-based entry. Such an indication can be entered into a database such as data store 103 illustrated in FIG. 1.

Alternatively, referring again to 1504, at 1505, based upon determining that the patient is not eligible for alternative funding, the hub can inform the patient and the MDO that the patient is not eligible for alternative funding by any suitable mode of communication and cancels the order.

In one nonlimiting, exemplary embodiment in which the specialty drug is ziconotide (PRIALT®), one or more of process flow 300 illustrated in FIG. 3, process flow 400 illustrated in FIG. 4, process flow 900 illustrated in FIG. 9, and process flow 1000 illustrated in FIG. 10 may include the following features:
A patient must have medical and/or prescription insurance coverage to be eligible for the Savings Program.
The patient pays the first $20 of their out-of-pocket costs (co-pay or co-insurance) attributable to their PRIALT® prescription. The PRIALT® Savings Program will then cover up to $660 for each 1-mL vial of PRIALT® on the pharmacy invoice, and up to $3,300 for each 5-mL or 20-mL vial on the pharmacy invoice. The total savings from participation in the PRIALT® Savings Program may not exceed $8,000 in a calendar year.
The benefit applies only to the portion of the out-of-pocket costs that are directly allocable to PRIALT®. Therefore, if the prescription includes any other medications, the out-of-pocket costs will include those allocable to such medications, which means the total out-of-pocket costs could be greater than $20.

Terms and Conditions of the program can include:

PRIALT® Savings Program Terms and Conditions
TO THE PATIENT: The PRIALT® Savings Program is open to eligible PRIALT® (ziconotide) intrathecal infusion patients with commercial insurance coverage only. If you have commercial insurance coverage for PRIALT®, and your cost-sharing obligation for PRIALT® is more than $20 for any PRIALT® prescription fill, you may receive up to $660 in savings off your out-of-pocket payment for each 1-mL vial of PRIALT® on the pharmacy invoice, and up to $3,300 in savings for each 5-mL or 20-mL vial on the pharmacy invoice. Your total savings from your participation in the PRIALT® Savings Program may not exceed $8,000 in a calendar year. Once you are enrolled in the program, the coupon will be applied to each refill unless and until you have reached the maximum annual savings. The PRIALT® Savings Program applies only to the portion of your out-of-pocket costs that are allocable to PRIALT® based on the actual invoice price for PRIALT®, and, therefore, if your prescription includes any other medications, your out-of pocket-costs for your prescription will include the full out-of-pocket costs allocable to such other medications, which means your out-of-pocket costs could be greater than $20.
For example, if the total invoice price for the medications in your prescription is $1,000, and the invoice price listed for PRIALT® is $900, 90% of the invoice price would be allocable to PRIALT®. If your out-of-pocket costs for the entire prescription equal $200, then 90% of that amount, or $180, would be allocated to PRIALT®. After deducting the initial $20 payable by you for PRIALT® under the program terms, the coupon would cover the remaining $160 of your out-of-pocket costs allocable to PRIALT®. You would be responsible for a total of $40 in out-of-pocket costs, the $20 (10%) allocable to other medications, and the initial $20 allocable to PRIALT®.
ELIGIBILITY REQUIREMENTS: This offer is good for patients with commercial insurance receiving 1-mL, 5-mL, or 20-mL vials of PRIALT® and may not be used for any other product. This offer is good for the purchase of PRIALT® manufactured for Jazz Pharmaceuticals, Inc. and lawfully purchased from an authorized pharmacy or distributor in the United States or Puerto Rico. This offer is not insurance and is not valid for prescriptions paid in full or in part by any state or federally funded health programs, including, but not limited to, Medicare (including Medicare Advantage and Part D plans), Medicaid, Medigap, VA, DOD or TriCare, or for patients who are Medicare eligible and enrolled in an employer-sponsored group waiver health plan or government subsidized prescription drug benefit program for retirees. Offer not valid where prohibited by law, taxed, or restricted. Offer is not transferable, is limited to one per person, and may not be combined with any other offer. Offer must be presented along with a valid prescription for PRIALT® at the time of purchase.
Your use of this coupon must be consistent with the terms of your health plan, and, as required, you agree to report use of this coupon to your health plan. When you use this coupon, you are certifying that you meet the eligibility criteria and that you will otherwise comply with the terms above.
Jazz Pharmaceuticals reserves the right to change or discontinue this offer at any time without notice.
If you have any questions regarding your eligibility or benefits, call the PRIALT® Savings Program at 1.855.PRIALT1 (774.2581) (8:00 am-8:00 pm EST, Monday-Friday).
TO THE HEALTHCARE PROVIDER AND THE PHARMACY: In order to confirm the amount of the benefit that the patient is entitled to, the healthcare provider or the pharmacy must submit an Explanation of Benefits form showing the patient's out-of-pocket costs, the insurance coverage for PRIALT®, and the amount paid for the prescription, to the NAVIGATOR Reimbursement and Access Program™. The forms may be submitted via fax at 1.855.PRIALT3 (774.2583), or mailed to BioScrip, Inc. Attention: NAVIGATOR Program, 2795 Charter Street, Columbus, Ohio 43228. When you use this coupon, you are certifying that you have not submitted and will not submit a claim for reimbursement under any federal, state, or other governmental programs for this prescription and that you will otherwise comply with the terms below.
   You represent that use of this coupon is not inconsistent with your obligations as a network provider for any health plan and, as required, you will report acceptance of funds provided through this coupon to such plans. Applicable discounts will be displayed in the transaction response
   No reimbursement may be sought from third-party payers for any part of the benefit received by the patient through this program
   Acceptance of this coupon and your submission of claims for the PRIALT® Savings Program are subject to the program Terms and Conditions, including those applicable to patient eligibility

In one nonlimiting, exemplary embodiment in which the specialty drug is ziconotide (PRIALT®), one or more of process flow 300 illustrated in FIG. 3, process flow 400 illustrated in FIG. 4, process flow 900 illustrated in FIG. 9, and process flow 1000 illustrated in FIG. 10 may include the following features:

This work instruction should be used if a patient who is commercially insured for PRIALT® (ziconotide) intrathecal infusion has an out-of-pocket (OOP) cost (co-pay, co-insurance and/or deductible) related to their PRIALT® prescription. This Work Instruction provides instructions as to how (i) to determine if the patient is eligible for the PRIALT® Savings Program (the “Program”); and (ii) if the patient is eligible, how to communicate with the provider and the patient regarding the Program. An eligible patient will be identified during the insurance verification process upon confirming that the patient meets the eligibility criteria as set forth in Step 1, and that the patient has an OOP for their PRIALT® prescription in excess of $20.
The following are the business rules for the Program:
Patients will be responsible for to the first $20 of the PRIALT® OOP amount
For prescriptions containing products in addition to PRIALT®, the OOP amount allocable to PRIALT® will be determined as set forth in Step 2 below.
Maximum Program Benefits to patients are equal to the following:
   $660 (or current WAC) OOP coverage for each 1 mL vial on the pharmacy invoice
   $3,300 (or current WAC) OOP coverage for each 5 mL and 20 mL vial on the pharmacy invoice
   Annual maximum benefit of $8,000

### Step 1. Confirming Patient Eligibility

NAVIGATOR TEAM will conduct a full benefit investigation based on a valid prescription request for PRIALT® and determine patients' expected out-of-pocket costs for PRIALT®.
NAVIGATOR TEAM will confirm patient eligibility based on the Program criteria established by Jazz as stated below:
   Patient has a valid prescription for PRIALT®
   Patient does not have medical coverage through federal or state health programs, including but not limited to Medicare or Medicaid, Medigap, VA, DOD or TriCare. or for patients who are Medicare eligible and enrolled in an employer-sponsored group waiver health plan or government-subsidized prescription drug benefit program for retirees
   Patient must have medical and/or prescription insurance coverage; cash payers are not eligible for the Program
   The OOP allocable to PRIALT® is in excess of $20.00.

### Step 2. PRIALT® Savings Program Calculation

NAVIGATOR TEAM will conduct the analysis for the patient OOP estimate based on the following calculation:
   The Percentage of OOP Attributable to PRIALT®=Total PRIALT® Invoice Dollar Amount/Total Prescription Invoice Dollar Amount
   The total invoice dollar amount is based on the prescription as written, and for purposes of determining the OOP estimate is equal to the estimated invoice dollar amount that will be billed for that prescription. The invoice amount must be allocated among all products contained in the prescription based on the cost to be charged to the patient.
   The Percentage of OOP attributable to PRIALT® will then be applied to the overall patient share of the Out Of Pocket as estimated by the Insurance Verification Process.
   After the PRIALT® OOP is determined, $20 must be deducted in order to determine the coupon savings amount, up to the maximum allowable.
   Example of the calculation: If the patient has more than one medication in his or her prescription, and the total invoice price for all of the medications in the patient's prescription is $1,000, and the invoice price listed for PRIALT® is $900, 90% of the invoice price would be allocable to PRIALT®. If the patient's out of pocket cost for the entire prescription equal $200, then 90% of that amount, or $180, would be allocated to PRIALT®. After deducting the initial $20 payable by the patient for PRIALT® under the Program terms, the coupon would cover the remaining $160 of the patient's out of pocket costs allocable to PRIALT®. The patient would be responsible for a total of $40 in out of pocket costs, the $20 (10%) allocable to the other medications and the initial $20 allocable to PRIALT®.

### Step 4. Informing Physician's Office of Eligibility During IVO Call and Arranging Delivery (Intake Specialist):

An Insurance Verification Outcome form, the letter to the healthcare provider, and the PRIALT® Savings Program Overview and Terms and Conditions will be faxed to the physician's office communicating the anticipated Program benefits for the patient along with instructions for how to bill the Program if the physician's office chooses buy & bill for the order.
After faxing the Insurance Verification Outcome form, the letter, and the Program Overview and Terms and Conditions, the Intake Specialist will contact the physician's office to let them know the patient is eligible for the Program and that the patient will be contacted by phone or by letter in order for the patient to confirm his or her election to be enrolled in the Program, and that you are calling as well to arrange for delivery.
Let the doctor know that if the patient's insurance situation changes that the patient would need to be re-evaluated to determine if the patient is still eligible for the Program.
Conduct the standard IVO call based on the IVO call Work Instructions and warm transfer the office to the pharmacy in order to confirm the prescription and delivery date.

### Step 4. Program Introduction to Patient (Intake Specialist or Patient Care Coordinator):

Once Step 2 has been completed, and the delivery date has been scheduled with the physician, conduct the standard Welcome or Refill Call per the appropriate Work Instructions. During the explanation of the patient out-of-pocket expense for their order, introduce the Program to the patient by adding the following to the Welcome or Refill Call:
“It appears that you are eligible for the PRIALT® Savings Program. The PRIALT® Savings Program is a program funded by the manufacturer of PRIALT® that is designed to provide assistance to eligible patients to help reduce the out of pocket costs for PRIALT®. You will be responsible for the first $20 of your out of pocket payment attributable to your PRIALT® prescription. Your total savings from your participation in the PRIALT® Savings Program may not exceed $8,000 in a calendar year. This Program applies only to the portion of your out of pocket costs that are directly allocable to PRIALT® based on the actual invoice cost for PRIALT®, and therefore if your prescription includes any other medications, your out of pocket costs for your prescription will include the out of pocket costs allocable to such medications.
“Based on your insurance coverage, the estimated expense for your current prescription will be ______ for a ______ day supply. The assistance provided by the Program has been applied to reduce the estimated out-of-pocket expenses for the PRIALT® portion of your prescription. (Explain the patient out-of-pocket cost here, including the additional OOP for any other medication not covered by the program and the total amount that the Program may cover). If in the future your insurance coverage changes, we will need to reevaluate your eligibility and the amount of your out of pocket expenses.
Refer to Doctor Medication Order Preference on the Insurance Verification Outcome form to confirm the payment due from patient:
   If the Provider indicates BioScrip Billing (Direct Bill):
      Medical Benefit: Explain that this amount will be billed to the patient by the BioScrip pharmacy once payment is received from the insurance company.
      Pharmacy Benefit: Explain that the total OOP amount will need to be collected by the pharmacy at this time. Transfer patient to the pharmacy to arrange for payment.
   If the Provider indicates Physician Buy and Bill:
      Explain that the OOP remaining after the Savings Program has been subtracted from the patient's total OOP will be payable to their physician.
      Next ask the patient if he or she wants to enroll in the Program:
      Do you want to enroll in the PRIALT® Savings Program?
      If the patient says yes, continue with the following:
      Thank you for your enrollment. We will send you a copy of the PRIALT® Savings Program Overview and Terms and Conditions.
      A package insert must be included with the copy of the Program Overview and Terms and Conditions, whether it is mailed or emailed.
      If the patient says no, inform the patient that they will not be enrolled in the Program and that they will therefore not receive the out of pocket reduction and then inform them what their out of pocket amount would be.
      Conclude the call with the standard Welcome or Refill Call Work Instructions.
      If the patient cannot be reached by telephone:
      Mail the Patient Letter, Program Overview and Terms and Conditions to the patient at the patient address listed on the enrollment form.

### Frequently Asked Questions

Q. What information is necessary to qualify a patient for the PRIALT® Savings Program?
A: The following is required:

1. A valid prescription for PRIALT®

2. A determination that the patient is eligible for the Program

3. Proof of insurance (Commercially insured patients only)

3. Out of pocket cost for PRIALT® is greater than $20.00

4. The Patient has affirmatively agreed to enroll in the Program, either verbally during the

Welcome Call, by calling the Navigator Program to enroll, or by sending in a written election to enroll
Q. Are patients enrolled in the CVC Financial Assistance Program already pre-qualified for the new PRIALT® Savings Program?
A: Patients currently enrolled in the CVC Financial program will stay in the CVC program. For new patients enrolled into the NAVIGATOR Program, eligibility for the Program will be determined first. If a patient should hit a threshold within the Program (for example, the maximum annual benefit) or otherwise be determined as ineligible for the Program, then that patient can be referred to the CVC for eligibility.

Note that the systems and methods may be implemented on various types of data processor environments (e.g., on one or more data processors) which execute instructions (e.g., software instructions) to perform operations disclosed herein. Non-limiting examples include implementation on a single general purpose computer or workstation, or on a networked system, or in a client-server configuration, or in an application service provider configuration. For example, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. For example, a computer can be programmed with instructions to perform some or all of the various steps of one or more of the flowcharts shown in FIGS. 3, 4, and 9-15.

It is further noted that the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

Further, the systems and methods, or any suitable portions thereof, may be provided on many different types of computer-readable storage media including computer storage mechanisms (e.g., non-transitory media, such as CD-ROM, diskette, RAM, flash memory, computer's hard drive, etc.) that contain instructions (e.g., software) for use in execution by a processor to perform the methods' operations and implement the systems described herein.

It will be appreciated that the computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

All publications and patent applications cited in this specification are herein incorporated by reference as if each individual publication or patent application were specifically and individually indicated to be incorporated by reference.

While examples have been used to disclose the invention, including the best mode, and also to enable any person skilled in the art to make and use the invention, the patentable scope of the invention is defined by claims, and may include other examples that occur to those of ordinary skill in the art. Accordingly the examples disclosed herein are to be considered non-limiting. As an illustration, although certain exemplary systems, methods, and computer readable media provided herein have been described with reference to distribution of specialty drugs for intrathecal administration, such as ziconotide, it should be understood that such systems, methods, and computer-readable media suitably may be adapted for use in distributing other specialty drugs with increased safety and reduced patient cost.

What is claimed is:

1. A method for distributing a specialty drug with increased safety and reduced patient cost, the specialty drug requiring specialized handling procedures and specialized prescription filling procedures, the method comprising:
by a computer hub operating at a single access point, enrolling a plurality of physicians and permitting the enrolled physicians to administer the specialty drug, to the exclusion of any other physicians;
using the specialized handling procedures, distributing the specialty drug from the single access point to a pharmacy specifically educated in the specialized handling procedures and the specialized prescription filling procedures, to the exclusion of any pharmacies that are not educated in the specialized handling procedures and the specialized prescription filling procedures, for delivery from the pharmacy exclusively to enrolled physicians responsive to prescriptions by those enrolled physicians for corresponding patients, each prescription being for at least the specialty drug; and
at the single access point, for each prescription, responsive to that prescription, determining whether the patient is currently enrolled in a commercial insurance plan, and
based upon the patient currently being enrolled in a commercial insurance plan, determining a patient out-of-pocket requirement of the commercial insurance plan and comparing the patient out-of-pocket requirement to a capped payment amount, and
based upon the patient out-of-pocket requirement exceeding the capped payment amount, calculating a total invoice amount of the specialty drug divided by a total invoice amount of the prescription to obtain a percentage of the total invoice attributable to the specialty drug, multiplying the percentage by the patient out-of-pocket requirement to obtain an initial patient obligation for only the specialty drug, and reducing the initial patient obligation for only the specialty drug to the capped payment amount.

2. The method of claim 1, further comprising transmitting the capped payment amount from the single access point to the pharmacy or the physician.

3. The method of claim 1, wherein the pharmacy:
receives the prescription for at least the specialty drug from one of the enrolled physicians;
fills the prescription of the specialty drug using the specialized prescription filling procedures; and
delivers the filled prescription exclusively to the one of the enrolled physicians using the specialized handling procedures.

4. The method of claim 3, wherein the one of the enrolled physicians intrathecally administers to the patient the delivered, filled prescription.

5. The method of claim 1, wherein the specialized handling procedures include just in time delivery of the specialty drug and for refrigerating the specialty drug so that the drug remains refrigerated throughout distribution and is not frozen.

6. The method of claim 1, wherein the specialized prescription filling procedures include preparing the prescription of the specialty drug exclusively for the patient, rather than as a portion of a batch that is prepared for multiple patients and divided.

7. The method of claim 1, wherein the specialized prescription filling procedures include admixing the specialty drug by the pharmacy with another drug.

8. The method of claim 1, wherein the specialty drug comprises an omega conopeptide.

9. The method of claim 8, wherein the specialty drug comprises ziconotide.

10. The method of claim 1, wherein the method is implemented by a manufacturer of the specialty drug or by a partner, agent, or affiliate of the manufacturer of the specialty drug, or a combination of such manufacturer and such partner, agent, or affiliate.

11. The method of claim 10, wherein the single access point is defined by the manufacturer of the specialty drug or by the partner, agent, or affiliate of the manufacturer of the specialty drug, or the combination of such manufacturer and such partner, agent, or affiliate.

12. The method of claim 11, wherein the partner, agent, or affiliate includes the pharmacy.

13. The method of claim 1, further comprising, by the computer hub, observing and analyzing trends in handling, ordering, patient adherence, and reimbursement of the specialty drug.

14. The method of claim 1, wherein the specialty drug is distributed to a single pharmacy, to the exclusion of all other pharmacies.

15. The method of claim 1, wherein the computer hub comprises a database.

16. The method of claim 1, wherein enrolling the physicians of the plurality of physicians comprises receiving from each physician an indicator of whether that physician selects Direct Bill or Buy and Bill.

17. The method of claim 1, further comprising receiving from enrolled physicians a plurality of enrollments for the corresponding patients.

18. The method of claim 1, further comprising referring the patient to a foundation for potential financial support.

19. The method of claim 18, wherein referring the patient to the foundation comprises, at the single access point, completing an application with the foundation on behalf of the patient.

20. The method of claim 1, wherein reducing the initial patient payment obligation comprises applying a coupon towards the patient out-of-pocket requirement.

21. The method of claim 1, further comprising limiting a total amount of savings that the patient may receive in a particular period of time.

22. A system for distributing a specialty drug with increased safety and reduced patient cost, the specialty drug requiring specialized handling procedures and specialized prescription filling procedures, the system comprising:
a computer hub operating at a single access point and configured to enroll a plurality of physicians and to permit the enrolled physicians to administer the specialty drug, to the exclusion of any other physicians; and
a distribution location using the specialized handling procedures to distribute the specialty drug from the single access point to a pharmacy specifically educated in the specialized handling procedures and the specialized prescription filling procedures, to the exclusion of any pharmacies that are not educated in the specialized handling procedures and the specialized prescription filling procedures, for delivery from the pharmacy exclusively to enrolled physicians responsive to prescriptions by those enrolled physicians for corresponding patients, each prescription being for at least the specialty drug;
wherein, at the single access point, for each prescription, responsive to that prescription, it is determined whether the patient is currently enrolled in a commercial insurance plan, and
based upon the patient currently being enrolled in a commercial insurance plan, a patient out-of-pocket requirement of the commercial insurance plan is determined and compared to a capped payment amount, and
based upon the patient out-of-pocket requirement exceeding the capped payment amount, a total invoice amount of the specialty drug divided by a total invoice amount of the prescription is calculated to obtain a percentage of the total invoice attributable to the specialty drug, the percentage is multiplied by the patient out-of-pocket requirement to obtain an initial patient obligation for only the specialty drug, and the initial patient obligation for only the specialty drug is reduced to the capped payment amount.

23. A system for distributing a specialty drug with increased safety and reduced patient cost, the specialty drug requiring specialized handling procedures and specialized prescription filling procedures, the system comprising:
means operating at a single access point for enrolling a plurality of physicians and to permit the enrolled physicians to administer the specialty drug, to the exclusion of any other physicians; and
means for using the specialized handling procedures to distribute the specialty drug from the single access point to a pharmacy specifically educated in the specialized handling procedures and the specialized prescription filling procedures, to the exclusion of any pharmacies that are not educated in the specialized handling procedures and the specialized prescription filling procedures, for delivery from the pharmacy exclusively to enrolled physicians responsive to prescriptions by those enrolled physicians for corresponding patients, each prescription being for at least the specialty drug;
means at the single access point, for each prescription, responsive to that prescription, for determining whether the patient is currently enrolled in a commercial insurance plan, and
means for, based upon the patient currently being enrolled in a commercial insurance plan, determining a patient out-of-pocket requirement of the commercial insurance plan and for comparing the out-of-pocket requirement to a capped payment amount, and
means for, based upon the patient out-of-pocket requirement exceeding the capped payment amount, calculating a total invoice amount of the specialty drug divided by a total invoice amount of the prescription to obtain a percentage of the total invoice attributable to the specialty drug, for multiplying the percentage by the patient out-of-pocket requirement to obtain an initial patient obligation for only the specialty drug, for reducing and the initial patient obligation for only the specialty drug to the capped payment amount.

24. A non-transitory computer-readable medium storing instructions for causing one or more processors at a single access point to distribute a specialty drug with increased safety and reduced patient cost, the specialty drug requiring specialized handling procedures and specialized prescription filling procedures, the instructions causing the one or more processors to perform steps comprising:
enrolling a plurality of physicians and permitting the enrolled physicians to administer the specialty drug, to the exclusion of any other physicians;
wherein a distribution location uses the specialized handling procedures to distribute the specialty drug from the single access point to a pharmacy specifically educated in the specialized handling procedures and the specialized prescription filling procedures, to the exclusion of any pharmacies that are not educated in the specialized handling procedures and the specialized prescription filling procedures, for delivery from the pharmacy exclusively to enrolled physicians responsive to prescriptions by those enrolled physicians for corresponding patients, each prescription being for at least the specialty drug;
wherein, at the single access point, for each prescription, responsive to that prescription, it is determined whether the patient is currently enrolled in a commercial insurance plan, and
based upon the patient currently being enrolled in a commercial insurance plan, a patient out-of-pocket requirement of the commercial insurance plan is determined and compared to a capped payment amount, and
based upon the patient out-of-pocket requirement exceeding the capped payment amount, a total invoice amount of the specialty drug divided by a total invoice amount of the prescription is calculated to obtain a percentage of the total invoice attributable to the specialty drug, the percentage is multiplied by the patient out-of-pocket requirement to obtain an initial patient obligation for only the specialty drug, and the initial patient obligation for only the specialty drug is reduced to the capped payment amount.
